(19) United States
(12) Patent Application Publication
(10) Pub. No.: US 2012/0251270 A1
(43) Pub. Date: Oct. 4, 2012

(54) BOOK BLOCK FINISHING MACHINE

(76) Inventors: Michael Speller, Aurora (CA); Ross Hoge, Kirkland (CA)

(21) Appl. No.: 13/375,543

(22) PCT Filed: Jun. 1, 2010
(86) PCT No.: PCT/CA2010/000832

§ 371 Date: Jun. 14, 2012

Related U.S. Application Data
(60) Provisional application No. 61/183,027, filed on Jun. 1, 2009.

(51) Int. Cl. B42C 9/00; B65G 47/31

(52) U.S. Cl. 412/8; 412/37; 198/461.2

(57) ABSTRACT

A book block finishing machine includes a forming unit to receive a printed web and a sheeting unit downstream from the forming unit to receive the web and to separate the web into at least one plurality of sheets. The machine also includes a batcher unit that includes at least one hopper to receive and stack each plurality of sheets to form at least one book block. The batcher unit also includes at least one adhesive applicator. Each adhesive applicator is operable to apply adhesive to at least one edge of each book block to bind together the plurality of sheets forming each book block.

### RELATED APPLICATIONS

This application claims the benefit U.S. Provisional Application 61/183,027, filed Jun. 1, 2009, this application being incorporated herein in its entirety by reference.

### FIELD

The described embodiments relate to a machine for handling and manipulating a continuous, printed web to create book blocks. Specifically, the described embodiments relate to a machine for processing a printed web into a book block for a finished product, such as a book, flyer or magazine.

### BACKGROUND

Creating books can include the step of creating a book block (individual sheets of paper stacked in numerical order in the form of a book) from individual sheets or pages cut or folded from a continuous, printed web or ribbon.

Digital printing presses are an alternative to traditional offset printing presses used to create multiple copies of a printed work. Using either digital or traditional offset printing press technology, after the web is printed in a continuous length that must be converted into a book. One method of converting a continuous web into a book involves the individual pages of the printed content (i.e. the book being printed) being cut, separated and stacked into book blocks. A portion of the printing press known as the finishing machine or book block finishing machine can perform at least some of these operations.

Known finishing machines tend to take a considerable amount of time to change format (i.e. to accept a different book block size and shape) which requires an associated digital printing press to stop for an extended period of time which can reduce the some of the “change-on-the-fly” advantage of digital printing presses.

Traditional book blocks assembled by known finishing machines can be very delicate before they are finally bound and can require very careful handling to prevent individual pages being lost or portions of the book block being separated. A single lost page can make a book block unusable and great care must be taken to ensure complete book blocks are transported without loss.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

According to one broad aspect, a method of assembling book blocks includes: receiving a continuous printed web; separating the web into a plurality of sheets; stacking the plurality of sheets in a hopper to form a book block; and applying adhesive to at least one edge of the book block so that the plurality of sheets forming the book block are bound together.

In some examples, the method also includes clamping the book block to inhibit relative movement between the plurality of sheets forming the book block while applying the adhesive.

In some examples, the method also includes moving the book block while applying the adhesive.

In some examples, the adhesive is applied using an adhesive applicator and the method also includes imparting relative movement between the book block and the adhesive applicator while applying the adhesive.

In some examples, the method also includes moving one of the book block and the adhesive applicator in a first direction while applying the adhesive.

In some examples, the method also includes simultaneously moving the one of the book block and the adhesive applicator in a second direction while applying the adhesive so that the adhesive traces a patch across the edge of the book block.

In some examples, the method also includes simultaneously moving the other of the book block and the adhesive applicator in a second direction while applying the adhesive so that the adhesive traces a patch across the edge of the book block.

In some examples, the book block is translatable in the first direction and the adhesive applicator is translatable in the second direction and three second direction is generally orthogonal to the first direction.

In some examples, the method also includes oscillating the adhesive applicator in the second direction while applying the adhesive.

In some examples, the method also includes oscillating the adhesive applicator in a consistent, predetermined frequency so that the path traced by the adhesive is generally sinusoidal.

In some examples, the method also includes the steps of: separating the web into at least two ribbons; aligning the at least two ribbons relative to each other; and simultaneously cutting each ribbon to form the plurality of sheets.

In some examples, the method also includes overlapping at least two of the at least two ribbons and justifying a reference edge of each overlapped ribbon to a common reference position.

In some examples, the common reference position is the location of a sidewall of the hopper.

In some examples, the method also includes identifying selected ones of the sheets and diverting the selected ones of the plurality of sheets to prevent the selected ones of the plurality of sheets from entering the hopper.

According to another broad aspect that can be used alone or in combination with any other aspect, a book block finishing machine includes a forming unit to receive a printed web and a sheeting unit downstream from the forming unit to receive the web and to separate the web into at least one plurality of sheets. The machine also includes a batcher unit that includes at least one hopper to receive and stack each plurality of sheets to form at least one book block. The batcher unit also includes at least one adhesive applicator. Each adhesive applicator is operable to apply adhesive to at least one edge of each book block to bind together the plurality of sheets forming each book block.

In some examples, the batcher unit further comprises at least one clamp to selectably clamp each book block while the adhesive is being applied.

In some examples, at least one of the at least one clamp and the at least one adhesive applicator is moveable relative to the other to impart relative movement between each clamped book block and the at least one adhesive applicator while the adhesive is being applied.

In some examples, each clamp is moveable in a first direction while the adhesive is being applied to move each clamped book block from an upstream position to a downstream position past the at least one adhesive applicator.

In some examples, each clamp comprises a lower clamp plate and an opposing upper clamp plate that is movable between an open position, in which the upper clamp plate is spaced apart from the lower clamp plate to allow the plurality of sheets to be received in each hopper, and a clamped position, in which the upper clamp plate is disposed toward the lower clamp plate, thereby clamping the book block between the upper and lower clamp plates.

In some examples, the upper and lower clamp plates contact the book block at a clamp position that is offset from the at least one edge of the book block so the upper and lower clamp plates are transversely spaced apart from the adhesive applicator as the shuttle moves between the upstream and downstream positions.

In some examples, each adhesive applicator is operable to apply a bead of adhesive to the at least one edge of the book block and each adhesive applicator is movable between first and second positions along a second direction. The second direction is at an angle to the first direction.

In some examples, each adhesive applicator can oscillate between its first and second positions as the clamp moves from the upstream position to the downstream position so that the bead of adhesive defines a predetermined path along the edge of the book block.

In some examples, the second direction is substantially orthogonal to the first direction.

In some examples, the adhesive applicator is moveable at a adhesive applicator speed, the adhesive applicator speed is selectably variable.

In some examples, the machine also includes an actuator drivingly connected to each adhesive applicator to move each adhesive applicator between its first and second positions.

In some examples, the machine also includes at least one height sensor to sense a height of each book block in the at least one hopper.

In some examples, the machine also includes a batcher unit controller linked to each sensor and each actuator. The batcher unit controller is operable to automatically control each actuator based on the sensed height of one corresponding book block.

In some examples, each hopper includes a gate at a downstream end thereof. The gate is movable between a closed position, in which the book block is retained within the hopper, and an open position, in which the book block can be removed from the hopper.

In some examples, each gate is moveable to accommodate book blocks of different book block lengths within each hopper.

In some examples, each hopper also includes opposing first and second sidewalls. Each first sidewall is moveable in a transverse direction relative its corresponding second sidewall to accommodate book blocks of different book block widths.

In some examples, each first sidewall defines a side jogger that can oscillate to jog the plurality of sheets entering each hopper in a transverse direction.

In some examples, each hopper also includes a rear support that defines a rear jogger that can oscillate to jog the plurality of sheets entering each hopper in a machine direction.

In some examples, the machine also includes an air nozzle directed into each hopper to introduce an air flow between sequential ones of the plurality of sheets entering each hopper to inhibit interference between sequential sheets.

In some examples, the machine also includes a shingle and interrupt unit to receive each plurality of sheets from the sheeting unit and at least partially overlap adjacent sheets to form corresponding shingled streams traveling in a machine direction.

In some examples, the shingle and interrupt unit also includes at least one first conveyor, at least a second conveyor downstream from each first conveyor. Each first conveyor can operate at a first speed that is slower than a fast conveyor speed so that sequential ones of each plurality of sheets will be at least partially overlapped when they are transferred from a fast conveyor to the first conveyor forming at least one shingled stream. Each second conveyor is selectably operable at a second speed that is faster than the first speed so that a gap can be formed between sequential ones of the plurality of sheets transferred from the first conveyor to the second conveyor.

In some examples, the machine also includes at least one interrupter opposing each first conveyor. Each interrupter is movable between a rest position, in which the at least one shingled stream can flow in downstream direction, and an activated position, in which the interrupter engages at least one sheet in the each of the at least one shingled streams to inhibit downstream movement of the at least one designated sheet.

In some examples, the interrupter comprises at least one page holding finger corresponding to each shingled stream. Each page holding finger is selectably moveable between the storage position and the activated position.

In some examples, each page holding finger is mounted on a support member that is translatable between an upstream position and a downstream position at the first speed so that downstream movement of the support member is synchronized with the speed of the at least one first conveyor.

In some examples, when each page holding finger is in the activated position it pinches the at least one sheet against a conveying surface of the at least one first conveyor to inhibit relative movement between the at least one designated sheet and the at least one first conveyor.

In some examples, the support member is translatable in the downstream direction while the at least one page holding finger is in the activated position.

In some examples, the interrupter further comprises at least one sensor mounted on the support member to sense a reference mark on the at least one shingled stream.

In some examples, the shingle and interrupt unit further comprises a shingle and interrupt controller linked to the at least one page holding finger and the at least one sensor. The shingle and interrupt controller is operable to automatically trigger the at least one page holding finger based on the sensed reference mark.

In some examples, the machine also includes at least one diverter that is positioned to selectably intercept each shingled stream and to selectably divert unwanted ones of the plurality of sheets out of each shingled stream to prevent the unwanted sheets from reaching the batcher unit.

In some examples, the diverter comprises a deflector positioned downstream from each second conveyor. Each deflector is selectably moveable between a diverting position, in which the deflector is positioned to intercept the unwanted sheets exiting the second conveyors and divert the unwanted sheets away from the batcher unit, and a storage position, in which the each shingle stream can flow past the diverter.

In some examples, when the deflectors are in the divert position they extend above a conveying surface of the second conveyors, and when the divert dates are in the storage position they are disposed below the conveying surface of the second conveyors.

In some examples, the machine also includes a third conveyor downstream from each second conveyor to receive the at least one shingled stream from each second conveyor and convey each shingled stream downstream to the batcher unit.

In some examples, the forming unit comprises a slitting unit that has an infeed unit to receive the printed web and a slitter assembly downstream from the infeed unit to separate the web into at least two ribbons. The slitter assembly comprises a plurality of slitters opposing a corresponding plurality of anvil surfaces. Each slitter is offset from its corresponding anvil surface to receiving the web therebetween and to slit the web when the web travels in a machine direction. At least one of the slitters is a moveable slitter that is moveable in the transverse direction.

In some examples, the machine also includes at least one actuator drivingly connected to each moveable slitter to move each movable slitter in the transverse direction.

In some examples, the machine also includes a slitter controller linked to each actuator. The slitter controller is operable to automatically move the moveable slitters.

In some examples, the machine also includes at least one sensor to sense the web width. Each sensor is connected to the slitter controller and the slitter controller is operable to automatically adjust the position of each moveable slitter based on the web width to separate the web into a predetermined number of ribbons.

In some examples, the machine also includes a slitter rail for supporting the plurality of slitters. Each moveable slitter is slidably mounted on the slitter rail. The slitter rail extends across a width of the web.

In some examples, the machine also includes an anvil member that comprises the plurality of anvil surfaces. The anvil member is aligned with the slitter rail.

In some examples, the forming unit is operable to separate the web into at least two ribbons and the machine also includes a ribbon shifting unit to receive the at least two ribbons and to align each ribbon with a predetermined reference position.

In some examples, the ribbon shifting unit also includes a frame moveably supporting at least one turn bar to receive each ribbon traveling in a first web direction and to redirect each ribbon to exit the ribbon shifting unit in a second web direction. Each turn bar is rotatable about a turn bar axis. The turn bar axis is at an oblique angle to the first and second ribbon directions. Each turn bar is positionable relative to the frame to justify a reference edge of each ribbon with the reference position.

In some examples, the reference position is based on the location of a sidewall of the at least one hopper.

In some examples, the machine also includes at least one turn bar pair and the at least two ribbons includes at least first and second ribbons. Each turn bar pair comprising first and second ones of the at least one turn bar for receiving the first and second ribbons respectively. The first and second turn bars are positionable relative to each other so that the first ribbon at least partially overlies the second ribbon as the first and second ribbons exit the ribbon shifting unit.

In some examples, wherein the reference edges of the first and second ribbons are justified to the same reference position.

In some examples, the machine also includes at least one sensor downstream from the at least one turn bar for sensing a reference mark on each ribbon.

In some examples, the machine also include at least one actuator connected the at least one turn bar to move the at least one turn bar relative to the frame.

In some examples, the machine also includes a ribbon shifting controller communicably linked to the at least one sensor and the at least one actuator. Each actuator is automatically controllable by the ribbon shifting controller based on at least the sensed reference mark.

In some examples, the at least one actuator is an electric servo motor.

In some examples, each turn bar is air lubricated.

In some examples, the forming unit is operable to separate the web into at least two ribbons and further comprising a compensator unit to receive the at least two ribbons and to longitudinally register each ribbon relative to at least one other ribbon.

In some examples, the compensator unit comprises a frame supporting a plurality of guide rollers to support each ribbon and a ribbon adjustment roller corresponding to each ribbon. Each ribbon adjustment roller is movably connected to the frame and is selectably movable to register the corresponding ribbon with at least one other ribbon.

In some examples, one ribbon of the plurality of ribbons defines a reference ribbon and the ribbon adjustment rollers are moveable so that the rest of the ribbons are registered relative to the reference ribbon.

In some examples, the machine also includes at least one actuator connected to each ribbon adjustment roller for moving each ribbon adjustment roller.

In some examples, the machine also includes a compensator controller linked to each actuator for automatically moving each ribbon adjustment roller.

In some examples, the machine also includes at least one sensor linked to the compensator controller to sense a current longitudinal position of at least one ribbon. The compensator controller is operable to compare the sensed current longitudinal position with a desired longitudinal position of the at least one ribbon and to automatically adjust the position of at least one ribbon adjustment roller based on the comparison.

According to another broad aspect that can be used alone or in combination with any other aspect, a batcher unit for use in a book block finishing machine includes at least one hopper to receive a plurality of sheets to form a book block and at least one adhesive applicator. Each adhesive applicator is operable to apply adhesive to at least one edge of the book block to bind together the plurality of sheets in the book block.

In some examples, the batcher unit further comprises at least one clamp to selectably clamp each book block while the adhesive is being applied.

In some examples, at least one of the at least one clamp and the at least one adhesive applicator is moveable relative to the other to impart relative movement between each clamped book block and the at least one adhesive applicator while the adhesive is being applied.

In some examples, each clamp is moveable in a first direction while the adhesive is being applied to move each clamped book block from an upstream position to a downstream position past the at least one adhesive applicator.

In some examples, each clamp comprises a lower clamp plate and an opposing upper clamp plate that is movable between an open position, in which the upper clamp plate is spaced apart from the lower clamp plate to allow the plurality of sheets to be received in each hopper, and a clamped position, in which the upper clamp plate is disposed toward the lower clamp plate, thereby clamping the book block between the upper and lower clamp plates.

In some examples, the upper and lower clamp plates contact the book block at a clamp position that is offset from the at least one edge of the book block so the upper and lower clamp plates are transversely spaced apart from the adhesive applicator as the shuttle moves between the upstream and downstream positions.

In some examples, each adhesive applicator is operable to apply a bead of adhesive to the at least one edge of the book block and each adhesive applicator is movable between first and second positions along a second direction and, the second direction being at an angle to the first direction.

In some examples, each adhesive applicator can oscillate between its first and second positions as the clamp moves from the upstream position to the downstream position so that the bead of adhesive defines a predetermined path along the edge of the book block.

In some examples, the second direction is substantially orthogonal to the first direction.

In some examples, the adhesive applicator is moveable at a adhesive applicator speed, the adhesive applicator speed is selectably variable.

In some examples, the batcher unit also includes an actuator drivingly connected to each adhesive applicator to move each adhesive applicator between its first and second positions.

In some examples, the batcher unit also includes at least one height sensor to sense a height of each book block in the at least one hopper.

In some examples, the batcher unit also includes a batcher unit controller communicably linked to each sensor and each actuator. The batcher unit controller is operable to automatically control each actuator based on the sensed height of one corresponding book block.

In some examples, each hopper also includes a gate at a downstream end thereof. The gate is movable between a closed position, in which the book block is retained within the hopper, and an open position, in which the book block can be removed from the hopper.

In some examples, each gate is moveable to accommodate book blocks of different book block lengths within each hopper.

In some examples, each hopper also includes opposing first and second sidewalls. Each first sidewall is moveable in a transverse direction relative its corresponding second sidewall to accommodate book blocks of different book block widths.

In some examples, each first sidewall defines a side jogger that can oscillate to jog the plurality of sheets entering each hopper in a transverse direction.

In some examples, wherein each hopper also includes a rear support that defines a rear jogger that can oscillate to jog the plurality of sheets entering each hopper in a machine direction.

In some examples, the batcher unit also includes an air nozzle directed into each hopper to introduce an air flow between sequential ones of the plurality of sheets entering each hopper to inhibit interference between sequential sheets.

According to another broad aspect that can be used alone or in combination with any other aspect, a shingle and interrupt unit includes at least one first conveyor to receive a plurality of sheets, and at least a second conveyor downstream from each first conveyor. Each first conveyor operating at a first speed that is slower than a fast conveyor speed so that sequential ones of each plurality of sheets will be at least partially overlapped when they are transferred from a fast conveyor to the first conveyor forming at least one shingled stream. Each second conveyor is selectably operable at a second speed that is faster than the first speed so that a gap can be formed between sequential ones of the plurality of sheets transferred from the first conveyor to the second conveyor. The shingle and interrupt unit also includes at least one interrupter opposing each first conveyor. Each interrupter is movable between a rest position, in which the at least one shingled stream can flow in a downstream direction, and an activated position, in which the interrupter engages at least one sheet in the each of the at least one shingled streams to inhibit downstream movement of the at least one designated sheet.

In some examples, the interrupter comprises at least one page holding finger corresponding to each shingled stream. Each page holding finger is selectably moveable between the storage position and the activated position.

In some examples, each page holding finger is mounted on a support member that is translatable between an upstream position and a downstream position at the first speed so that downstream movement of the support member is synchronized with the speed of the at least one first conveyor.

In some examples, when each page holding finger is in the activated position it pinches the at least one sheet against a conveying surface of the at least one first conveyor to inhibit relative movement between the at least one designated sheet and the at least one first conveyor.

In some examples, the support member is translatable in the downstream direction while the at least one page holding finger is in the activated position.

In some examples, the interrupter also includes at least one sensor mounted on the support member to sense a reference mark on the at least one shingled stream.

In some examples, the shingle and interrupt unit also includes a shingle and interrupt controller linked to the at least one page holding finger and the at least one sensor. The shingle and interrupt controller is operable to automatically trigger the at least one page holding finger based on the sensed reference mark.

In some examples, the shingle and interrupt unit also includes at least one diverter positioned to selectably intercept each shingled stream and to selectably divert unwanted ones of the plurality of sheets out of each shingled stream to prevent the unwanted sheets from continuing downstream past the diverter.

In some examples, the diverter comprises a deflector positioned downstream from each second conveyor, each deflector selectably moveable between a diverting position, in which the deflector is positioned to intercept the unwanted sheets exiting the second conveyors, and a storage position, in which the each shingle stream can flow past the diverter.

In some examples, when the deflectors are in the divert position they extend above a conveying surface of the second conveyors, and when the divert dates are in the storage position they are disposed below the conveying surface of the second conveyors.

In some examples, the shingle and interrupt unit also includes a third conveyor downstream from each second conveyor to receive the at least one shingled stream from each second conveyor and convey each shingled stream further downstream.

According to another board aspect that can be used alone or in combination with any other aspect, a method of justifying ribbons includes: receiving at least a first and a second ribbon; overlapping the first ribbon with the second ribbon; aligning a reference edge of the first ribbon with a predetermined reference position; aligning a reference edge of the second ribbon with the same predetermined reference position.

In some examples, the reference position is aligned with an input position of a batcher unit.

In some examples, the method also includes receiving the first and second ribbons traveling in a first web direction and redirecting the first and second ribbon to travel in a second web direction.

It is understood that an embodiment may contain one or more of the aspects and/or features set out in the examples, in a plurality of combinations and sub-combinations. It is also understood that examples described in relation to a certain aspect may be used in combination with other aspects and other examples. Any single embodiment need not contain all of the features set out above.

### BRIEF DESCRIPTION OF THE FIGURES

For a better understanding of the book block finishing machine described herein and to show more clearly how they may be carried into effect, reference will now be made, by way of example only, to the accompanying drawings which show at least one exemplary embodiment, and in which:

FIG. 1 is an isometric view of a book block finishing machine;

FIG. 2 is a side view of a slitting unit;

FIG. 3 is a partial isometric view of the slitting unit of FIG. 2;

FIG. 4 is a top view of a ribbon shifting unit receiving eight ribbons;

FIG. 5 is a top view of the ribbon shifting unit of FIG. 4 receiving six ribbons;

FIG. 6 is an isometric view of the ribbon shifting unit of FIG. 5;

FIG. 7a is a side view of a compensator unit;

FIG. 7b is an isometric view of the compensator unit of FIG. 7a;

FIG. 7c is an enlarged view of the indicated portion of FIG. 7b;

FIG. 8 is a side view of a sheeting unit and a shingle and interrupt unit;

FIG. 9 is a side view of the shingle and interrupt unit of FIG. 8 and a partial side view of a batcher unit;

FIG. 10 is a side view of another example a shingle and interrupt unit disposed between a sheeting unit and a batcher unit;

FIG. 11 is a side view of another example of a shingle and interrupt unit;

FIG. 12 is a side view of the shingle and interrupt unit of FIG. 11;

FIG. 13 is a side view of the shingle and interrupt unit of FIG. 11 with a page holding finger in an engaged position;

FIG. 14 is a side view of the shingle and interrupt unit of FIG. 13;

FIG. 15 is another side view of the shingle and interrupt unit of FIG. 13;

FIG. 16 is a side view of the shingle and interrupt unit of FIG. 13 with the page holding finger in a storage position;

FIG. 17 is another side view of the shingle and interrupt unit of FIG. 16;

FIG. 18 is another side view of the shingle and interrupt unit of FIG. 16 showing a deflector in a first position;

FIG. 19 is a side view of the shingle and interrupt unit of FIG. 18 with the deflector in a diverting position;

FIG. 20 is an isometric view of a batcher unit;

FIG. 21 is a side view of the batcher unit of FIG. 20 with a book block received in a hopper;

FIG. 22 is a side view of the batcher unit of FIG. 21 with the book block moved downstream of the hopper;

FIG. 23 is a flow chart of a process for operating a book block finishing machine;

FIG. 24 is a partial isometric view of another example of a batcher unit;

FIG. 25a is a section view taken along line 25-25 in FIG. 24 with a shuttle in an upstream position; and

FIG. 25b is a section view taken along line 25-25 in FIG. 24 with the shuttle in a downstream position.

For simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

The following description is not to be considered as limiting the scope of any claimed invention, but rather as providing an example within each claimed invention. However, each example may not be an embodiment of each claimed invention, for instance a particular claim might relate to only one exemplary device. The claims should not be interpreted as necessarily including all of the features of any example, or all of the examples or requiring features common to all of the examples. The applicants, inventors and owners reserve all rights that they may have in any invention disclosed in an apparatus or process described below that is not claimed in this document, for example the right to claim such an invention in a continuing application and do not intend to abandon, disclaim or dedicate to the public any such invention by its disclosure in this document.

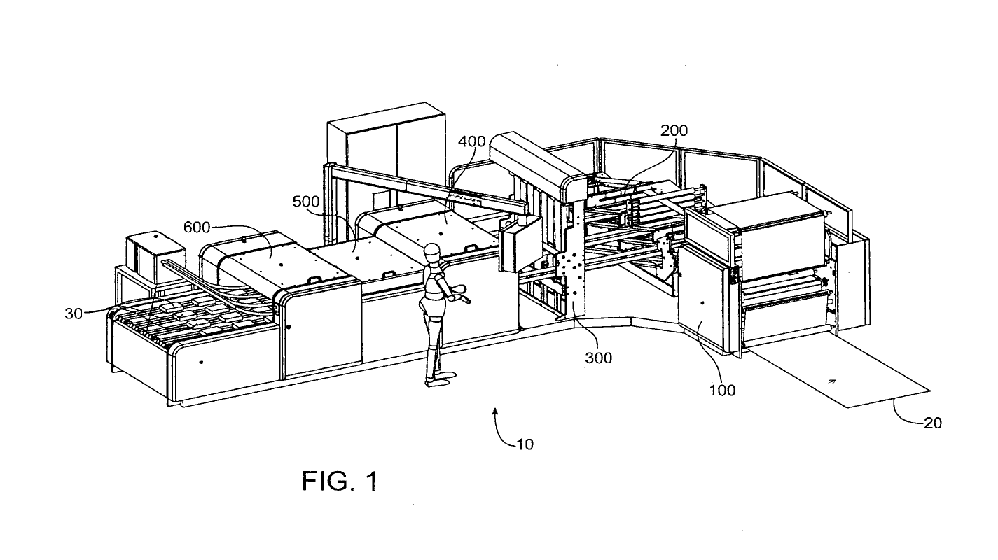

Referring to FIG. 1, an embodiment of the present invention relates to a book block finishing machine 10, including a forming unit, for example slitting unit 100, a ribbon shifting unit 200, a compensator unit 300, a sheeting unit 400, a shingle and interrupt unit 500 and a batcher unit 600. The book block finishing machine 10 is configured to receive an incoming web 20 and to convert the incoming web 20 into a plurality of book blocks 30. The incoming web 20 is advanced through the book block finishing machine 10 in a longitudinal or machine direction which is represented in the present figures by arrow 12. The direction generally orthogonal to the machine direction can be referred to as the lateral or transverse direction.

For the purposes of this description, a book block 30 comprises a plurality of sheets of paper, stacked in order, generally taking the form of a book without a cover or other permanent binding. Book blocks 30 may be formed having a variety of physical dimensions (length and width) based on the requirements of the finished book (i.e. paper back, hardcover, coffee table book, etc.) and may contain a variety of numbers of pages depending on the length of the book being printed. Varying the number of pages in a book block 30 may vary the height of the book block 30. While the term book block 30 is generally used in this description to describe a plurality of pages arranged in order to form the text of a book, it is understood that the term book block 30 also refers more generally to any collection of stacked sheets or pages, the contents of which may be a book or any other type of printed media, including flyers, catalogues, directories and manuals.

The incoming web 20 is generally a continuous, moving sheet of paper (or other suitable material) upon which desired text and/or graphics is printed. The book block finishing machine 10 may be configured to operate in an “on-line” capacity, in which the incoming web 20 is received from a printing press (digital or offset) in real time (i.e. the printed web exiting the printing press is fed into the book block finishing machine 10. In another example, the book block finishing machine 10 may be configured to operate in an “off-line” capacity in which the incoming web 20 is unwound from a spool or roll of pre-printed material, as opposed to coming directly from the output of a printing press. In either example, the web 20 is supplied to the book block finishing machine 10 at a given linear velocity or web speed that can be expressed in absolute terms, for example the web can be traveling at 10 linear feet per second, or in relative terms, for example the web can be traveling at 400 sheets per minute (which may represent a variety of different velocities depending on the length of each sheet).

Optionally, a given book block finishing machine 10 may be re-configurable so that it can be configured to operate in both the on-line and off-line modes. Further, while the incoming web 20 is illustrated as a single web in the example of the book block finishing machine 10 described below, it is understood that other examples of the incoming web 20 may comprise two or more webs running at the same time. For example, a book block finishing machine may be configured to receive an incoming web having a maximum width of 48″; in this example the book block finishing machine may be supplied with a single web (of a width up to 48″) or it may be supplied with two, 20″ webs or four 10″ webs. The maximum and minimum web dimensions that the book block finishing machine can accommodate may be based on user specifications.

The ability to receive multiple, independent webs may be advantageous as it may allow the book block finishing machine to simultaneously receive multiple, different webs and to produce corresponding multiple, different book blocks. This may enable the book block finishing machine 10 to simultaneously produce book blocks for different books (i.e. having different printed content and possibly different dimensions and page counts) as well as for a plurality of streams of the same book. As explained in further detail below, depending on the configuration of the book block finishing machine, the multiple incoming webs may be limited to having the same dimensions with differing content and page counts, or they may have the additional flexibility of having different content, page count and dimensions.

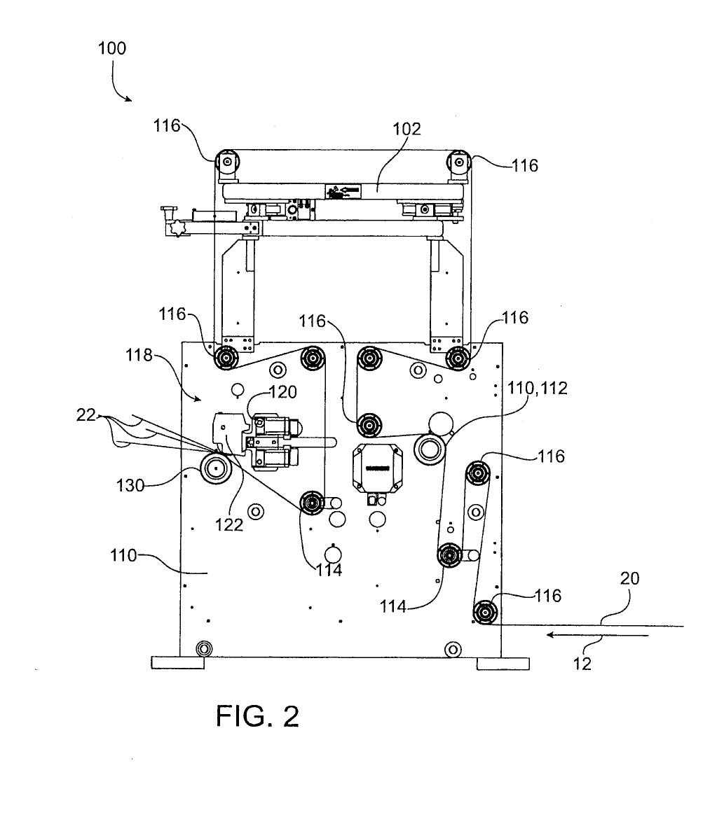

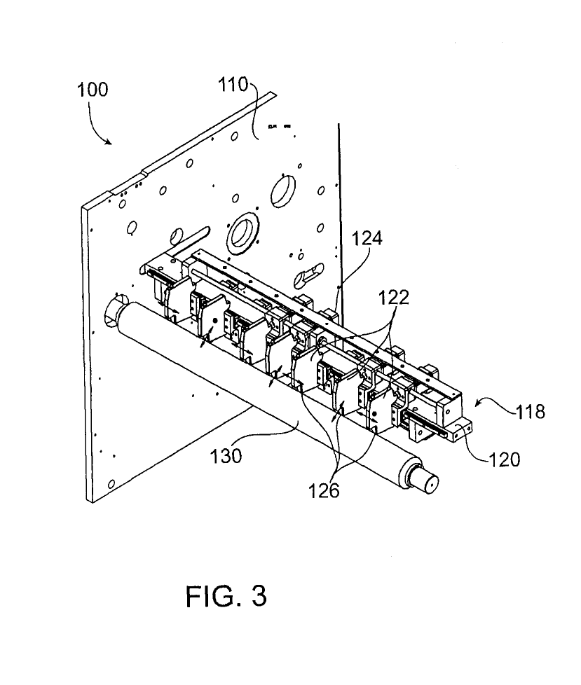

Referring to FIGS. 2 and 3, an example of a forming unit to form the incoming web into a desired number of ribbons is shown. In this example the forming unit is a slitting unit 100 for separating the incoming web into two or more ribbons. The slitting unit 100 comprises an infeed unit 110, a web guide system 106 and a slitter assembly 118 mounted on a frame 102 and is configured to receive the incoming web 20 (moving from right to left as shown in FIG. 2) and to separate or cut the incoming web 20 into multiple ribbons 22. The web is separated so that each ribbon 22 contains a predetermined set or grouping of printed frames arrange in the longitudinal direction.

When the book block finishing machine 10 is in use, the web 20 enters the slitting unit 100 via an infeed unit 100. The infeed unit 100 comprises an infeed roll and nip 112 that engages the web 20 and maintains a desired operating tension on the web 20. Throughout the slitting unit 100, the web 20 is also engaged and routed by a plurality of rollers 116. Optionally, some or all of the rollers 116 may be driven or passive. A pair of load cells 114 is also used to further monitor or provide tension feedback of the web 20. Prior to being cut by the slitters 126, the web is passed through a web guide system 102 that may position the web 20 in the centre of the slitting unit 100 (or other desired position) so that the web 20 is properly aligned with the slitters 126.

The slitter assembly 118 includes rail 120 that is substantially parallel with and offset from an anvil 130. Both the rail 120 and the anvil 130 may be generally orthogonal to the web 20. The anvil 130 may be fixed or rotatable, passive or driven and may be a cylinder (as shown) or any other suitable shape. The rail 120 extends from the frame 102 of the slitting unit 100 in a direction that is generally orthogonal the movement of the web 20. A plurality of slitter holders 122, each containing a slitter 126 (which can be any suitable slitting means, including, for example a knife, blade or cutter) are attached to the rail so that the slitters 126 cooperate with the corresponding anvil surfaces, which in this example are portions of anvil 130, to form a cutting edge or cutting point where the web 20 is separated along its length (i.e. in the longitudinal direction) into two or more ribbons 22.

To allow the slitting unit 100, and specifically the slitting assembly 118 to be used with a variety of different incoming webs 20 having different cutting/slitting requirements, each slitter holder 124 may be movably or slidably mounted on the rail 120 so that the distance between adjacent slitter holders 122 (and slitters 126 held therein) can be adjusted. In one example of the book block finishing machine 10, each of the slitter holders 122 can be independently moved. In another example, some of the slitter holders 122 may be moved along the length of the rail 120 while other slitter holders 122 are fixedly positioned in desired locations (for example at one edge of the web or in the centre of the web).

The positions of the slitter holders 122 and slitters 126 may be manually adjusted by a machine operator who moves each slitter holder 122 to its desired position. Alternatively, one or more of the slitter holders 122 may be connected to an actuator so that the slitter holders 122 can be automatically adjusted by a computer, PLC or other control system. The actuator used to move the slitter holders 122 may be any type of mechanical, electrical, hydraulic or pneumatic actuator having the desired accuracy and response time. In the example illustrated the actuators used to automatically adjust the position of the slitter holders 122 are servo motors 124 connected to each slitter holder 122. In some examples the slitter holders 122 are repositioned/adjusted when the book block finishing machine 10 is not running (i.e. the web 20 is not moving through the slitting unit 100). In other examples the slitter holders 122 may be repositioned “on the fly” while the web 20 is running through slitting unit 100. To reduce the likelihood of jamming or other problems, the web 20 may be run at a reduced speed (i.e. slower than normal production speed) when the slitter holders 122 are being repositioned.

As the web 20 passes through the slitter assembly 118 it may be cut into two or more ribbons 22. Optionally the web 20 may continue through the book block finishing machine 10 without being slit if, for example the web 20 is the width of the desired finished book. In such examples the web 20 would be handled like any other ribbon 22. In the following description the term ribbon may include a single web that was not slit.

In other examples, the web 20 may be arranged into a desired configuration using another type of forming unit, for example by folding the web 20 in a predetermined manner to provide ribbons that are suitable for cutting into individual sheets. When a single web is folded, each ply of the web can be considered a ribbon, so that a folded web can include two or more overlapped ribbons. When cut into separate longitudinal sheets, each sheet may remain attached along one edge to another sheet in another ribbon while still being considered separate sheets (i.e. each ply of the folded sheets forms a separate page in the finished book once the folded edge is trimmed off later in the process).

Optionally, the forming unit can include a combination of slitting and folding units. For example, a slitting unit can be provided that slits and incoming web into four sub-webs and then each sub-web can be folded in half (about a longitudinal folding axis) to provide a total of eight ribbons as described herein (four sub-webs each folded into a two-ply form to define two overlapping ribbons).

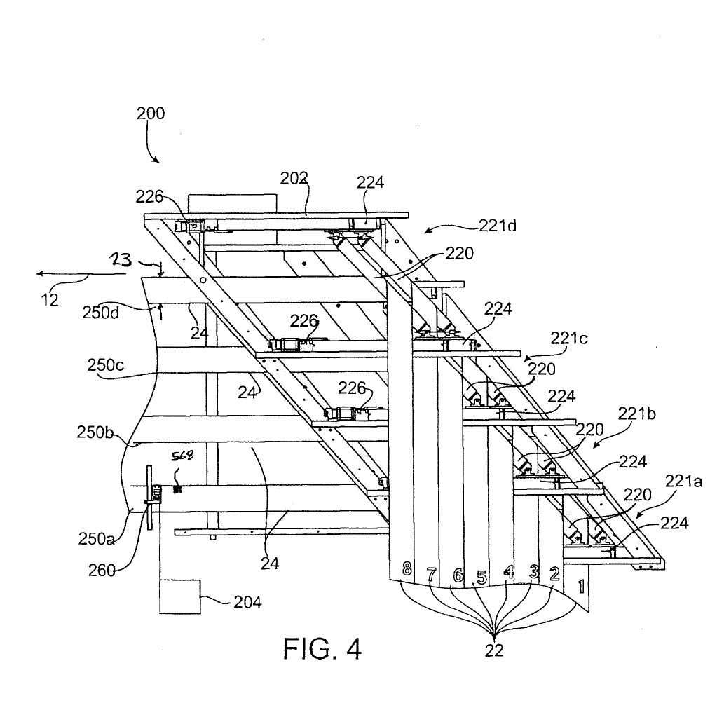

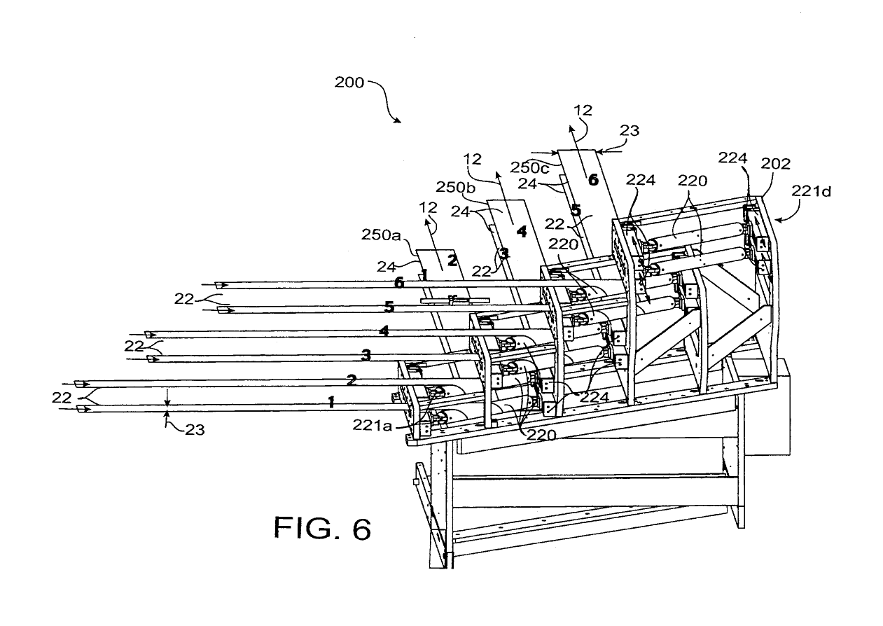

Each ribbon 22 has a width 23 (FIGS. 4 and 6) that generally corresponds to the width of the book being created. The width 23 of the ribbon 22 may be slightly wider than the desired finished product to allow for aligning, trimming and binding. In some examples, when traveling as a single, integral web 20 and immediately after being slit each ribbon 22 is registered with (or aligned with) each adjacent ribbon 22 so that the frames on each ribbon 22 (i.e. the printed area, for example one page of a book) are aligned with each other. Aligning the frames on each ribbon creates a common cut line or cutting location across all of the ribbons 22.

After exiting the slitting unit 100 the ribbons 22 pass through a ribbon shifting unit 200. Referring now to FIGS. 4-6, one example of a ribbon shifting unit 200 is shown comprising a frame 202 that movingly supports a plurality of turn bar pairs 221a-d. Each turn bar pair 221a-d comprises two turn bars 220 that are connected to the frame 202 by linear bearings 224 so that each turn bar 220 can translate relative to the frame 202. Each turn bar 220 is rotatable about a turn bar axis that is defined by the longitudinal axis of each turn bar. The turn bar axes are at an oblique angle relative to the machine direction of the incoming ribbons (indicated by arrow 12), for example an angle of 45 degrees to the machine direction. As the ribbons 22 approach the turn bars 220 they are traveling in a first ribbon direction. The travel direction of the ribbons 22 is modified by their passing over the turn bars 220 so that the ribbons 22 leave the ribbon shifting unit traveling in a second ribbon direction that is at an angle, for example generally orthogonal to, the first ribbon direction. For the purpose of this description, both the first and second ribbon directions are examples of the machine or longitudinal travel direction. That is, the machine travel direction refers to the direction of travel of the web 20 or ribbons 22 at a particular point or location within the book block finishing machine 10, which can change along the length of the machine 10.

Optionally, each turn bar 220 can move independently of any other turn bar 220. Like the slitter holders 122 described above, the turn bars 220 may be manually positioned by a machine operator or may be automatically controller by a system controller or computer. To enable remote control of the turn bar 220 position each turn bar 220 may be connected to and driven by a computer controller servo motor 226, or other suitable actuator. At least a portion of the turn bars 220 may be lubricated, preferably air lubricated, to reduce the likelihood of damaging the ribbons 22.

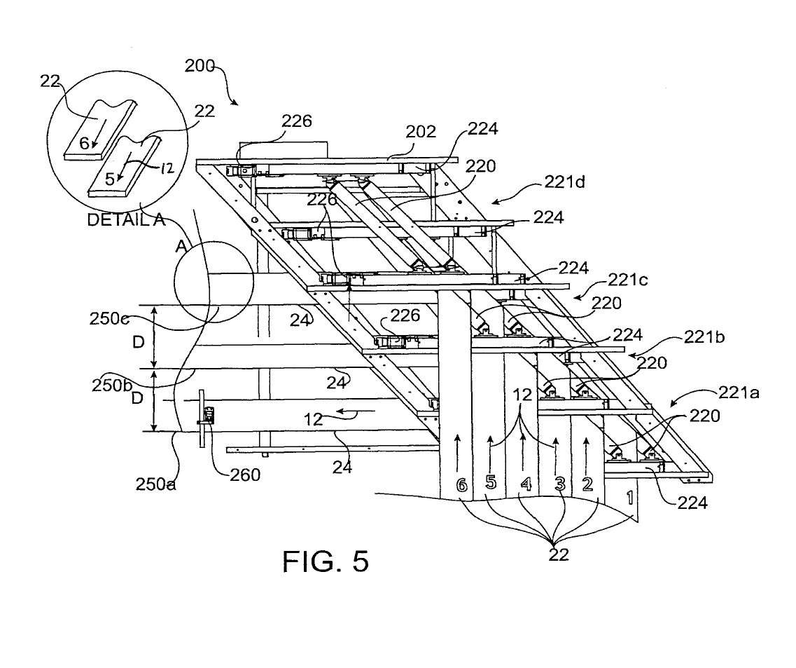

The ribbon shifting unit 200 includes at least one turn bar 220 for each incoming ribbon 22. For example, FIG. 4 shows an 8-bar ribbon shifting unit 200 receiving eight ribbons 22 (numbered in the figures using numbers 1-8 for clarity and to illustrate the path of each ribbon); one ribbon 22 engaging each turn bar 220. Alternatively, as shown in FIGS. 5 and 6, the 8-bar ribbon shifting unit 200 can be operated using fewer than eight incoming ribbons 22, in which case only a portion of the turn bars 220 are engaged by a ribbon 22 and the remaining turn bar pair 221d (at the top of FIG. 5) remains idle during the operation of the book block finishing machine 10.

As the ribbons 22 pass through the ribbon shifting unit 200 their direction of travel is changed (by approximately 90 degrees in the examples shown) and the ribbons 22 are positioned in a desired configuration relative to the book block finishing machine 10 and to each other. While an 8-bar ribbon shifting unit 200 is shown (capable of handling one to eight ribbons 22) it is understood that in some examples of the book block finishing machine 10 a larger or smaller ribbon shifting unit may be used in combination with corresponding slitting units 100 and batcher units 600, described in more detail below. In other words, the book block finishing machine 10 design is scalable so as to be operated on a larger (more than eight ribbons) or smaller (less than eight ribbons) scale.

In the example of the ribbon shifting unit 200 shown, the ribbons 22 exiting the ribbon shifting unit 200 (having passed over their respective turn bars 220) are arranged in a stacked configuration, for example as shown in FIG. 6. That is, the ribbons 22 passing through a turn bar pair, for example turn bar pair 221c, are generally adjacent each other as they enter the turn bars 220 and the turn bars 220 are positioned so that the ribbons 22 are vertically stacked (i.e. one overlying the other) when they exit the turn bar pair 221c (in other examples the ribbons 22 may be stacked in another orientation or they may be in a non-stacked configuration). In addition to being stacked, each ribbon 22 exiting the turn bar pair 221a-d is positioned so that a reference edge 24 of each ribbon 22 is aligned with or justified to a reference position 250a-d corresponding to each turn bar pair 221a-d.

The location of the reference positions 250a-d may be based on the input positions of the sheeting unit 400 and the batcher unit 600 (for example the position of a side wall of each hopper) or a combination thereof, as described in more detail below. The reference positions 250a-d are spaced apart by a known distance D, which may be based on the configuration of the batcher unit 600 or other suitable factors.

The distance D may be the same between each reference position 250a-d, or it may be different between each reference position 250a-d. In some examples, changes to the configuration of any one unit 200, 400 or 600 may require corresponding changes to the other units. For example, if the configuration of the hoppers in the batcher unit 600 is changed to accommodate books of a different size the location of the reference positions 250a-d may have to be adjusted accordingly so that the ribbons 22 coming out of the ribbon shifting unit 200 are properly aligned with the batcher unit 600. In other examples, the locations of the reference positions 250a-d may remain constant when the size or number of ribbons changes, and other units and features of the machine can be set and/or adjusted to accommodate ribbons 22 that are justified to the reference positions 250a-d.

If the web 20 is split into an odd number of ribbons 22 then the ribbon shifting unit 200 may operate with one turn bar pair 221a-d receiving only a single ribbon 22. For example, if a web 20 is slit into five discrete ribbons 22 then two turn bar pairs, for example 221a and 221b, may receive two ribbons 22 while a third turn bar pair, for example 221c, may receive only a single ribbon 22. In such an example, the outputs of turn bar pairs 221a and 221b would be stacked pairs of ribbons 22, both of which having their reference edges 24 aligned with reference positions 250a and 250b respectively, whereas the output of turn bar pair 221c would be a single ribbon 22 having its reference edge 24 aligned with reference position 250c.

It is understood that the ribbon slitting unit 200 can be configured to align single ribbons 22 and pairs of stacked ribbons 22 to a desired reference position and that other examples of the ribbon shifting unit (having different ranges of turn bar overlap and spacing) may be configured to output multiply stacked ribbons (i.e. triple-stacked or quadruple-stacked ribbons) and to align each stack of ribbons with a desired reference position.

For example, four incoming ribbons may be passed through the ribbon shifting unit without stacking to produce four separate output streams. Alternatively, four incoming ribbons may be shifted to create two, stacked output streams. In yet another example, four incoming ribbons may be shifted to create one stacked output stream and two single ribbon output streams. Similarly, five incoming ribbons may be shifted into a plurality of different possible combinations of output streams, including two double stacked streams and a single stream, and one double stacked stream and three single streams.

The printed web 20, and optionally each separate ribbon 22, may include a registration mark, batch mark 568 or graphic that is printed on the web/ribbon and is readable by at least one sensor 260, that can be operated as a print register sensor, as the web 20/ribbons 22 advance through the book block finishing machine 10. The registration mark may identify the beginning of the printed information on the ribbon 22, the location of a particular frame (or other location) on the ribbon, the location of a cut point between frames on the ribbon 22, the end of a printed section on the ribbon or other machine instruction information. The information obtained by reading (or otherwise scanning) the registration mark on a web may be used to control a number of functions of the book block finishing machine 10, including controlling the operation of the compensator unit 300, the cut-off knife in the sheeting unit 400, the shingle and interrupt unit 500 and the batcher unit 600.

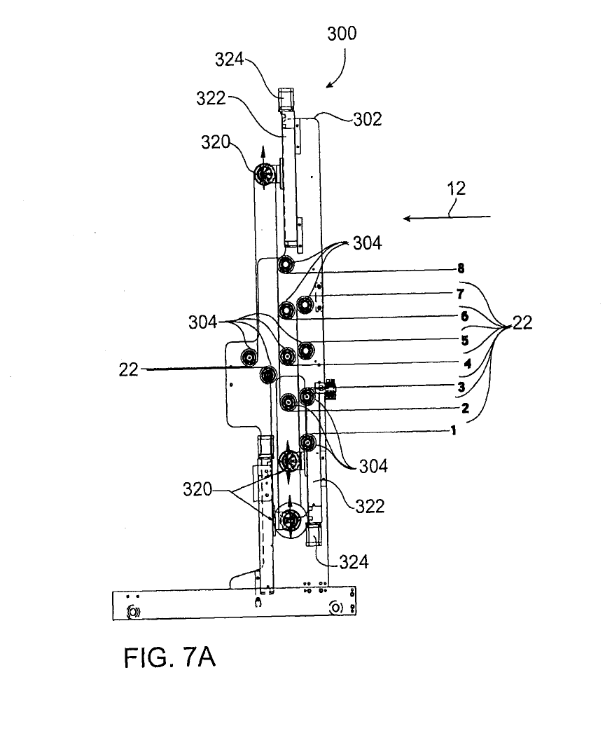

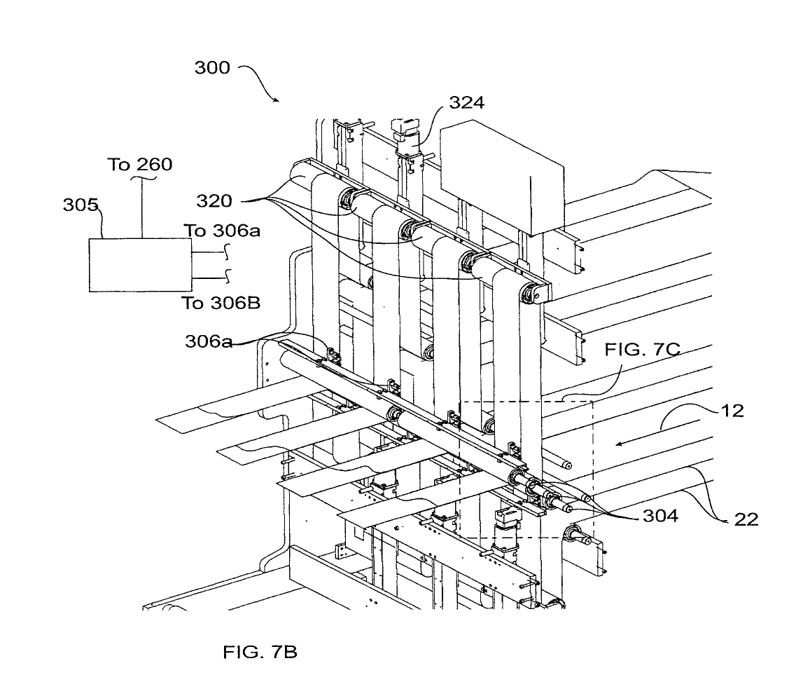

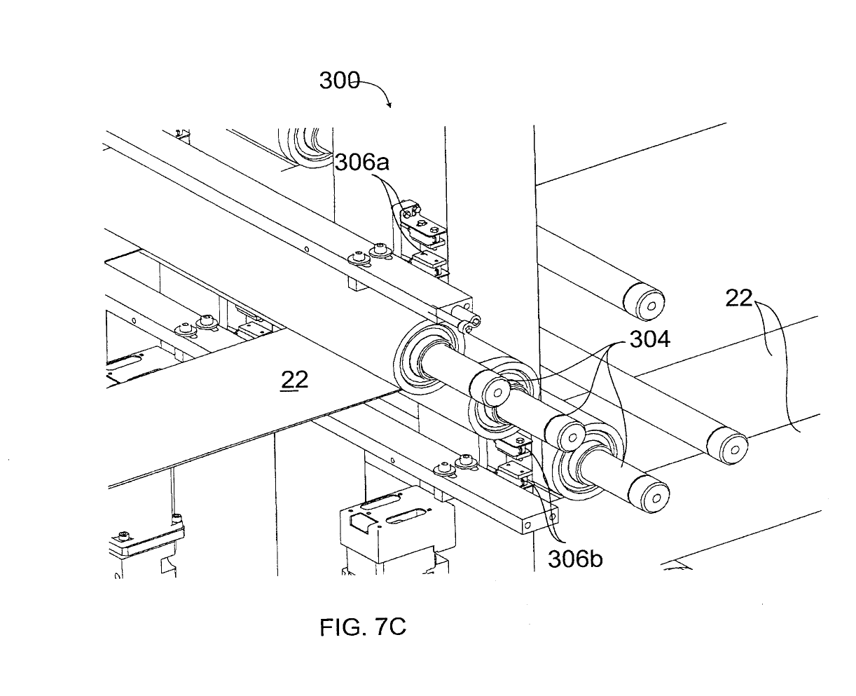

Also referring to FIGS. 7A-7C, sensors 306a,b can also be configured to sense whether the ribbons are properly aligned with their corresponding reference positions, i.e. to operate as a reference edge sensor. For example, the sensors 306a,b can be operable sense a reference mark (which can be any type of mark or structural feature including the edge of the ribbon) to determine if the reference edge 24 of one or more of the ribbons 22 is aligned with its corresponding reference position 250a-d. In some examples, the sensors 306a,b can include a plurality of individual sensors, with one sensor being provided to monitor the reference edge position of each ribbon. In the illustrated example, the ribbon shifting unit 200 is configured to direct eight separate ribbons, and could be configured to include eight separate reference edge sensors.

Some or all of the sensors 306a,b can be communicably connected to a ribbon shifting controller or control module 204. The ribbon shifting controller 204 can also be connected to some or all of the actuators 226 that are used to adjust the position of corresponding turn bars 220, which in turn adjusts the lateral or transverse position of the ribbons 22 passing through the ribbon shifting unit 200. The ribbon shifting controller 220 can be configured to receive ribbon position data from the reference edge sensors and compare the current ribbon position to the corresponding, desired reference position 250a-d. If a given ribbon is misaligned, the ribbon shifting controller 204 can be configured to automatically control the appropriate actuator 226 to re-align the ribbon. In such examples, the ribbon shifting unit 200 can function as a closed-loop system that is capable of making ribbon 22 alignment adjustments without relying on operator input or other external controls. The ribbon shifting controller 204 can be any suitable type of controller, including for example a computer or PLC, and can be configured as a stand alone unit (as shown), interconnected to other machine controllers and control systems, or formed as a module contained within a larger controller.

The reference edge sensors can be configured to operate in real-time, so that the position of the reference edge of each ribbon 22 is continuously monitored (at a suitable sampling rate) while the book block binding machine 10 is in use. The ribbon shifting unit 200 can also be configured so that the positions of the turn bars 220 can also be continuously adjusted in real-time, and while the machine 10 is in use, which may reduce the need to slow down or stop the book block binding machine 10 to adjust or re-adjust the lateral positions of the ribbons 22.

In the example of the book block finishing machine 10 illustrated, a print register sensor 260 scans at least one of the ribbons 22 exiting the ribbon shifting unit 200 (downstream of the turn bars 220) in order to identify the position of the ribbon 22 relative to the book block finishing machine 10. This position information can be used for a variety of diagnostic and control purposes, including to determine location of cut-off points or page breaks along the length of the printed ribbon 22. The cut-off position information can be sent to the sheeting unit 400 and used to control the operation of the cut-off knife. This position information may also be used by the compensator unit 300 to coarsely or roughly pre-position the ribbon adjustment rollers described below. This pre-positioning of the ribbon adjustment rollers may be advantageous as it may allow the ribbon adjustment rollers to be moved into an approximate position based on the register information received from the print register sensor 260 which may reduce the distance travel and corresponding time required to precisely position the ribbon adjustment rollers when the ribbons 22 pass through the compensator unit 300.

Referring now to FIGS. 7a-c, an example of a compensator unit 300 for receiving the ribbons 22 from the ribbon shifting unit 200 is shown. The compensator unit 300 comprises a frame 302 which supports a plurality of guide rollers 304, for supporting and routing each ribbon 22 through the compensator unit 300, and a plurality of ribbon adjustment rollers 320. In the example shown the compensator unit 300 comprises one ribbon adjustment roller 320 for each incoming ribbon 22; other examples of compensator units 300 may comprise a greater or fewer number of ribbon adjustment rollers.

The compensator unit 300 is configured to adjust the position of each ribbon 22 in the machine direction so that all of the ribbons 22 can be longitudinally registered relative to each other in the same relative positions as when they each formed part of the incoming web 20. That is, the longitudinal position of the ribbons 22 can be adjusted so that they are registered with respect to each other so that when the ribbons exit the compensator unit 300 each the frame on each ribbon 22 is aligned with the same frame of an adjacent ribbon as when the web 20 entered the slitting unit 100.

To align and register the ribbons 22 the example of the compensator unit 300 described herein uses a plurality of moveable ribbon adjustment rollers 320. Each ribbon adjustment roller 320 is connected to the frame 302 using a linear bearing 322 that allows the ribbon adjustment roller to translate relative to the frame 302. In the example shown the ribbon adjustment rollers 320 are shown as being moveable in the vertical direction, but it is understood that the ribbon adjustment rollers may be moveable in other directions. The ribbon adjustment roller 320 for each ribbon 22 may be independently movable and may be manually adjusted by an operator or automatically controlled and adjusted using an automatic actuator, for example an electric servo motor 324.

By moving the ribbon adjustment rollers 320 (relative to the frame 302 and the guide rollers 304) the compensator unit 300 changes the path length between the inlet and outlet of the compensator unit 300 which allows the relative longitudinal positions of the ribbons 22 to be adjusted. In some examples, the ribbons 22 may be registered to a known, external reference point or position. In other examples a particular ribbon 22 that is scanned as it exits the ribbon shifting unit 200 may be used as a virtual zero point or reference ribbon to which all the other ribbons 22 are registered. In some examples, one or more ribbon adjusting rollers 320 supporting the reference ribbon point may be fixedly connected to the frame 320.

In the example described all of the ribbons 22 are registered with respect to each other so that upper and lower ribbons in a stacked configuration are registered with each other, and with all of the other adjacent ribbons. Such a configuration may be desirable when all ribbons contain the same printed content. In other examples, all of the ribbons may not include the same printed contact and it may not be necessary to register all of the ribbons to the same position. Each separate ribbon stream, or pair of stacked ribbons, may be registered to a different position. It may however still be desirable to register the ribbons in a stacked configuration so that they have common cut-off points. In some examples of the book block finishing machine 10, the compensator unit 300 may be adjusted “on the fly” (i.e. without a break in production) to accommodate different print jobs having a different number of pages or a different frame dimension (i.e. page length) that are printed consecutively on the same ribbon 22. This may be particularly advantageous when the book block finishing machine 10 is used in combination with a digital printing press that is capable of changing print jobs on the fly.

Optionally, the position of the ribbon adjustment rollers 320 may be automatically controlled in a closed-loop manner, based on the information received from the print register sensors, or other suitable sensors that can be located upstream or downstream from the compensator unit 300, enabling the compensator unit 300 to quickly react to changes in the ribbons 22 (i.e. a change in printed content). A compensator controller 305 can be communicably linked (using any suitable cable or connection means) between the sensors used to determine the current longitudinal position of each ribbon and the servo motors 324. The compensator controller 305 can automatically compare the current longitudinal position data for each ribbon 22 to the desired longitudinal position for each ribbon (either an external reference point or relative positioning as described above) in real-time and adjust the position of the appropriate ribbon adjustment roller 320 using the corresponding servo motor 324. This enables a continuous closed-loop and automatic monitoring and adjusting of the longitudinal position of each ribbon 22.

In addition to be registered, the output stream of the compensator unit 300 may be vertically aligned with the input of the sheeting unit 400 so that both ribbons 22 in a stacked configuration (i.e. both plies of layers of material) stay registered as they travel the same distance into the sheeting unit 400 at the same rate.

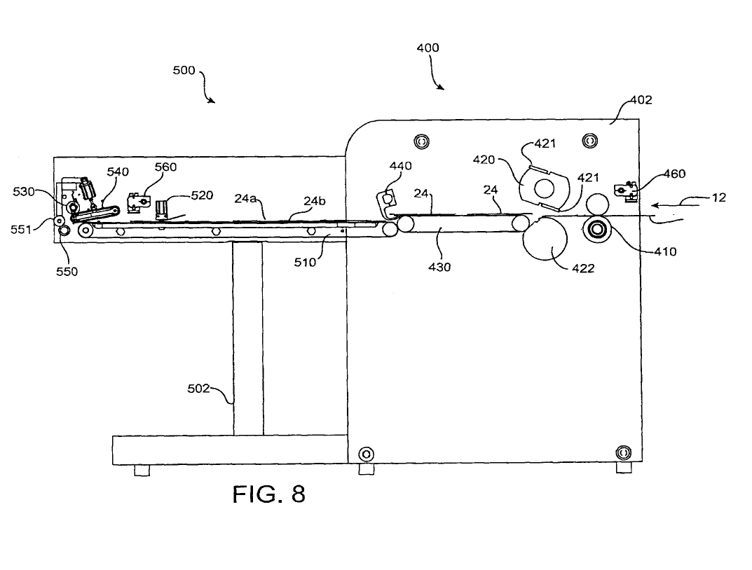

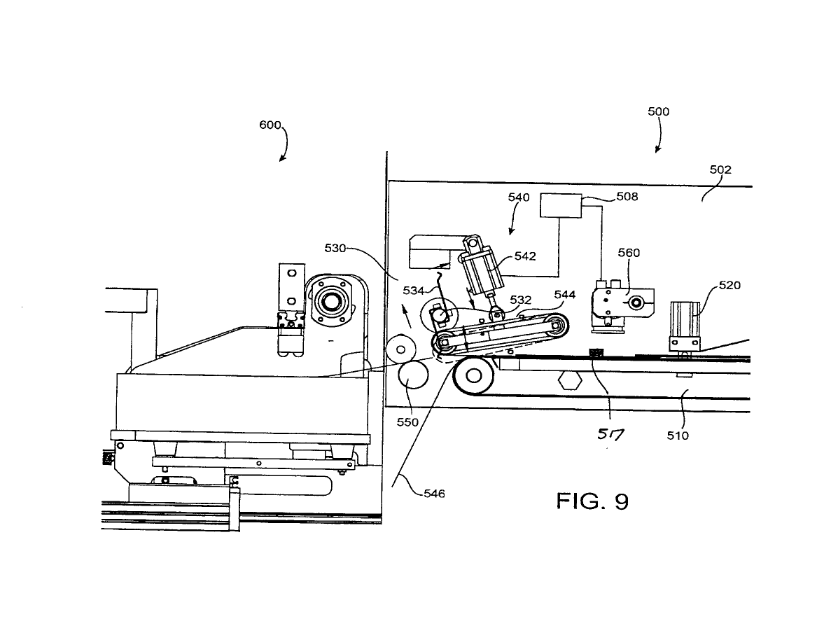

After passing through the compensator unit 300, the ribbons 22 are fed into the sheeting unit 400 which cuts the continuous ribbons 22 into a plurality of discrete sheets 26. Referring now to FIGS. 8 and 9, an example of a sheeting unit 500 and a shingle and interrupt unit 600 are shown.

The illustrated example of a sheeting unit 400 comprises a frame 402 which supports sheeter nip 410, a rotating sheeter knife 420, a lower knife or anvil 422, a fast conveyor 430, a rotating beater 440 and a print register sensor 460. The fast conveyor 430 operates at a fast conveyor speed.

The sheeter nip 410 is used to maintain the desired ribbon tension between the sheeter nip 410 and the infeed roller and nip 112 described above. As the ribbons 22 pass through the sheeter nip 410 they are no longer under the same tension that was present between the slitting unit 100 and the sheeter nip 410. Upstream of the sheeter nip 410 (where the ribbons 22 are still under tension) another print register sensor 460 scans an incoming ribbon to determine its appropriate cut-off locations. The data from the print register sensor 460 is used to precisely control the rotational speed of the rotating sheeting knife 420 to ensure that the ribbon is cut at the desired location. In some examples, the speed of the sheeting knife 420 can be roughly calibrated based on the information from the upstream print register sensor 260. Using the data from the upstream print register sensor 260 enables the sheeter knife 420 to be brought up to roughly the required speed in advance of the printed register mark being scanned by the sheeter print register sensor 460 (which is physically close to the sheeter knife 420), which may reduce sheeter knife 420 lag and may improve sheeter knife 420 response time and accuracy.

As the sheeter knife 420 rotates it periodically engages the lower knife or anvil 422 thereby cutting the ribbon 22 positioned between the sheeter knife 420 and the anvil 422. In the example shown the sheeter knife 420 includes two blades 421 allowing the sheeter knife 420 to make to cuts per rotation. It is understood that other examples of the sheeter knife may include a greater or fewer number of blades. It is also understood that a single continuous sheeter knife may be used to cut all ribbons simultaneously (when all of the ribbons are registered with each other) or multiple sheeter knifes may be used to enable each stream of ribbons to be cut separately, at different locations. In some examples where multiple sheeter knives are used the sheeting unit 400 may include a plurality of print register sensors 460 for registering each stream (i.e. a single ribbon or multiple, registered stacked ribbons) of ribbons with its respective sheeter knife.

Downstream of the sheeter knife 420 is a fast conveyor system, for example the fast conveyor belt 430. The conveyor is described as a “fast” conveyor as it is moving at a fast conveyor speed that is a faster rate of speed than the ribbons 22 being fed into the sheeting unit 400. Accordingly, when a sheet 24 contacts the fast conveyor belt 430 after being cut by the sheeter knife 420 it is rapidly moved away from the sheeter knife 420 so that a space is formed between each sheet 24. The fast conveyor belt 430 may be any type of conveyor known to those in the art. Some or all of the conveyors used in the machine 10 may incorporate a vacuum system and for upper gravity weighted wheels to keep individual sheets 24 in contact with the appropriate conveyors.

The individual sheets 24 carried on the fast conveyor belt 430 are then transferred to a relatively slower conveyor, for example the first conveyor 510, on the shingle and interrupt unit 500. The first conveyor 510 operates at a first conveyor speed that is slower than the fast conveyor speed. Optionally, the sheeting unit 400 may include a rotating beater 440 that knocks down the trailing edge of each sheet 24 as the sheet 24 is transferred from the fast conveyor belt 430 to the slow conveyor belt 510 to prevent multiple sheets 24 from jamming or otherwise interfering with each other.

FIGS. 8 and 9 show one example of a shingle and interrupt unit 500 comprising a frame 502 that supports a conveyor belt 510, a shingled stream arrester 520, an interrupter 530, a diverter 540, a driven roller 550 and a batch sequence sensor 560.

As explained above, the conveyor belt 510 moves at a relatively slower rate of speed than the fast conveyor 430 so that sheets 24 received on the conveyor belt 510 are partially overlapped or shingled. That is, at least a portion of a first sheet 24a on the conveyor belt 510 is overlapped by a second sheet 24b, as shown in FIG. 8. In some examples, the speed of the conveyor belt 510 is variable or adjustable and the amount of overlap or shingling of the sheets 24 may be correspondingly variable. For example the conveyor belt 510 may be operable between the ribbon speed (i.e. the process speed or the web speed) and a fraction thereof, for example half ribbon speed, or one tenth ribbon speed.

As the shingled sheets 24 move along the conveyor belt 510 the print register mark printed on the sheet(s) 517 is scanned by the batch sequence sensor 560. Like the sheeter unit 400 above, in examples where the book block finishing machine 10 is configured such that the ribbon streams are not all registered with each other, the shingle and interrupt unit may comprise multiple batch sequence sensors to scan each stream independently. In such a configuration, the conveyor belt 510 may also have a plurality of separately controlled regions (spaced transversely across the shingle and interrupt unit 500) for varying the speed of each stream independently of its neighbouring streams.

Based on the information read using the batch sequence sensor 560 may be used to activate the interrupter 530 and diverter 540 in order to remove certain sheets 24 from the stream before they enter the bather unit 600. A single and interrupt controller 508 can be communicably connected between some or all of a sensor (for example the batch sequence sensor 560), the interrupter 530 and the diverter 540 to obtain data from the sensor and automatically control the interrupter 530 and/or diverter 540 in real-time, based on the data. For example, a sheet 24 in a stream may have a batch symbol or an “end of job” symbol printed thereon at a predetermined number of sheets before the end of the current print job, for example 10 sheets before the last page of the book being printed. This “end of job” symbol (and all symbols used or scanned by the book block finishing machine 10 sensors) may be a graphic, a colour code, a bar code, text, an image, a line, a three dimensional bar code, an embossment, a hole or any other type of symbol that can be read by the sensors of the book block finishing machine. Similarly, all sensors described herein (for example 260, 460 and 560) may be optical sensors, cameras, laser scanners or any other type of sensor capable of recognizing the symbol on the ribbon 22 or sheets 24. In the present example, the “end of job” symbol may be a bar code that contains a “10 pages to go” warning for the book block finishing machine.

Reading symbols from the ribbons 22 may be advantageous as it allows each unit in the book block finishing machine 10 to react to the incoming ribbon without relying on a centrally controlled clock, timing system or computer software process. However, in some examples, the sensors on the book block finishing machine may be replaced with a central control or timing system that is based on software controls, algorithms or a clocking system.

In response to the end of job symbol, the interrupter 530 may be activated to interrupt the flow of sheets 24 advancing toward the batcher unit 600 at the appropriate location (i.e. 10 sheets after the symbol appeared) based on the location of the symbol and the speed of the conveyor belt 510. Optionally, to make the interrupting process easier to control and to improve accuracy the conveyor belt 510 may be slowed when the end of job symbol is scanned so that the sheets 24 will be moving more slowly when intersected by the interrupter 530. Other symbols on the ribbons may contain different process instructions or information. In some examples a ribbon 22 may include a single batch symbol, while in other examples each ribbon may include a plurality of different symbols along its length.

In the example shown in FIGS. 8 and 9 the interrupter 530 includes a driven shaft or spindle 532 onto which a pair of arms 534 are mounted. The shaft 532 is configured to rotate in the direction the sheets 24 are flowing and is adapted with hooks toward the distal end of each arm. In other example the interrupter 530 may include a greater or fewer number of arms 534 and the arms may comprise other sheet engaging portions, including rubber pads, clips, adhesive portions and abutment faces. Like the rotating beater 440, the interrupter 530 rotates in the direction of the flow of the sheets 24 to reduce the chances of jamming or otherwise interfering with the sheets 24. Based on the input from the batch sequence sensor 560, the interrupter 530 can interrupt the stream of sheets 24 at a precise location, thereby controlling which sheets 24 advance into a given book block or batch of sheets in the batcher unit 600.

In some examples the sheets 24 in the stream may include multiple print jobs (i.e. batch of printed pages or a second copy of the book being printed) printed on the sheets 24 consecutively, without any gaps, waste or blank pages between the last page of one print job and the first page of the following print job. In these circumstances, the diverter 540 may not be utilized and the interrupter 530 may simply disengage from the stream of sheets 24 and allow the sheets 24 to flow into the batcher unit 600. In other examples, multiple print jobs on the ribbon 22/sheets 24 may be separated by a number of blank pages, ink jet calibration pages or other unwanted material. In these examples the diverter 540 may be used to divert a desired number of sheets 24 from the stream to prevent the unwanted sheets from entering the batcher unit 600 when the interrupter 530 is removed from the stream.

In the example shown the diverter 540 comprises a belt assembly 544 that is movably connected to the frame 502 by a diverter actuator 542. When the diverter 540 is not required it is stored in a rest or storage position (or first position) in which it is spaced apart from the conveyor belt 510 and the belt assembly 544 does not engage the sheets 24. When the diverter 540 is activated (based on the scanned symbols and the activation of the interrupter 530) the diverter 540 moves into a use or active position by the diverter actuator 542 (a second position) in which the belt assembly 544 engages the sheets 24 carried by the conveyor belt 510, creating a nip. The belt assembly 544 is arranged at an angle to the conveyor belt 510 so that sheets 24 engaged by the diverter belt assembly 544 are directed downward, out of the process stream and into a waste bin or other waste handling apparatus, before the sheets 24 can contact the driven roller 550, as exemplified by unwanted sheet 546 in FIG. 9. The diverter 540 then remains engaged with the sheet stream until unwanted sheets have been removed from the stream. Disengagement of the diverter 540 may be based on time, a discarded sheet count, the reading of another symbol in the sheet stream (i.e. a “begin next batch here” symbol) or any other suitable input or combination thereof. After the diverter 540 has disengaged the sheets 24, the interrupter 530 can disengage the sheets 24 enabling the sheets 24 to resume their flow into the batcher unit 600.

To reduce the accumulation of sheets 24 at the interrupter 530, the flow of sheets 24 can be partially or completely throttled/stopped by the shingled stream arrester 520, or by changing the speed of the conveyor belt 510, or a combination thereof.

Because the flow of sheets 24 may be interrupted by the interrupter 530, optionally the shingle and interrupt unit 500 may comprise a driven roller 550 that is downstream of the interrupter 530 and that is nipped by a series of gravity weighted idler rollers 551. Sheets 24 engaging the driven roller 550 may be propelled or advanced into the batcher unit 600 by the driven roller 550 despite the stream disruptions caused by the interrupter 530. The speed and operation of the driven roller 550 may be based on or tied to the speed of the conveyor belt 510.

Like the ribbon shifting unit 200, compensating unit 300 and sheeter unit 400 described above, the shingle and interrupt unit 500 may be configured to handle a variety of input sheet streams that correspond to the arrangement of the upstream units. In some examples, each stream of sheets advancing through the shingle and interrupt unit 500 may be interrupted and diverted in unison (if the ribbons/sheets are all registered) and in other examples the shingle and interrupt unit may include the necessary hardware (i.e. multiple independent interrupters and diverters) so that each stream may be interrupted and diverted independently.

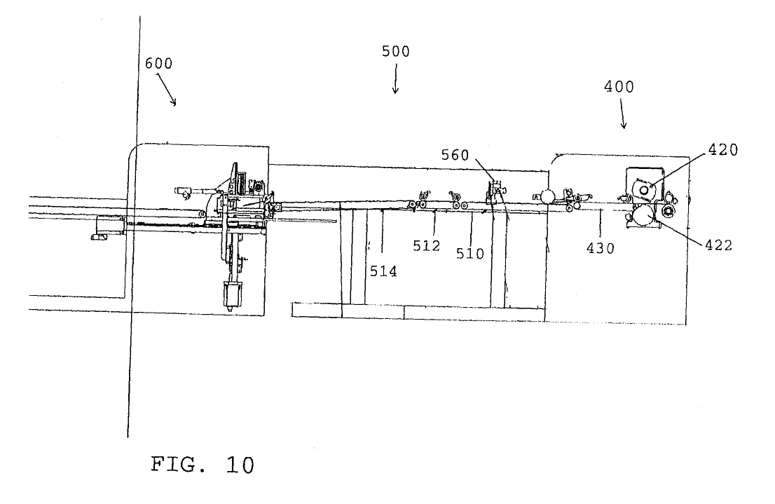

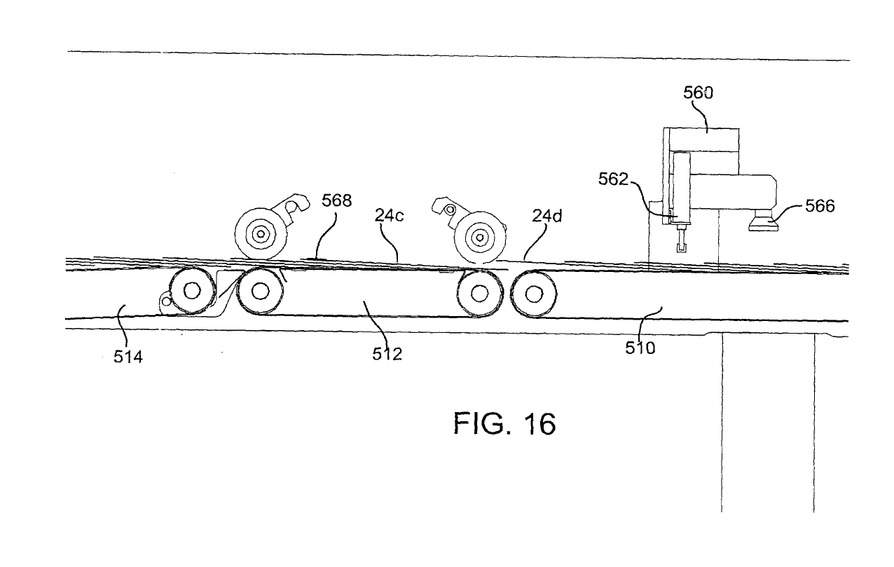

Referring to FIGS. 10-19 another example of a shingle and interrupt unit 500 includes three separate conveyors, a first or upstream conveyor 510, a second or intermediate conveyor 512 and a third or downstream conveyor 514. Optionally, the three conveyors 510, 512, 514 can be separately controllable so that they can each be operated at a different speed if desired.

As described in detail above, the first conveyor 510 can be operated at a slower speed than the fast conveyor 430 in the sheeting unit 400, so that the individual sheets 24 will at least partially overlap, or shingle, when transferred from sheeting unit 400 to shingle and interrupt unit 500. Also, as described above, each steam of shingled sheets 24 can sequentially include the contents of multiple books that are to be collected and formed into separate book blocks. To enable a desired separation in the shingled streams, the operating speed of the second and third conveyors 512, 514 can be adjusted. Increasing the speed of the second and third conveyors 512, 514 relative to the first conveyor 510, and optionally each other, can increase the spacing between sheets 24, and decreasing the speed of the second and third conveyors 512, 514 relative to the first conveyor 510, and optionally each other can decrease the spacing between sheets 24. Independently adjusting the speeds of the second and third conveyors 512, 514 allows for a gradual or stepped transition from the relatively slow speed of the first conveyor 510 to the relatively faster (or slower) speed of the third conveyor 516. The speed of the conveyors 510, 512, 514 can be automatically controlled by a shingle and interrupt controller or manually controlled by a machine operator.

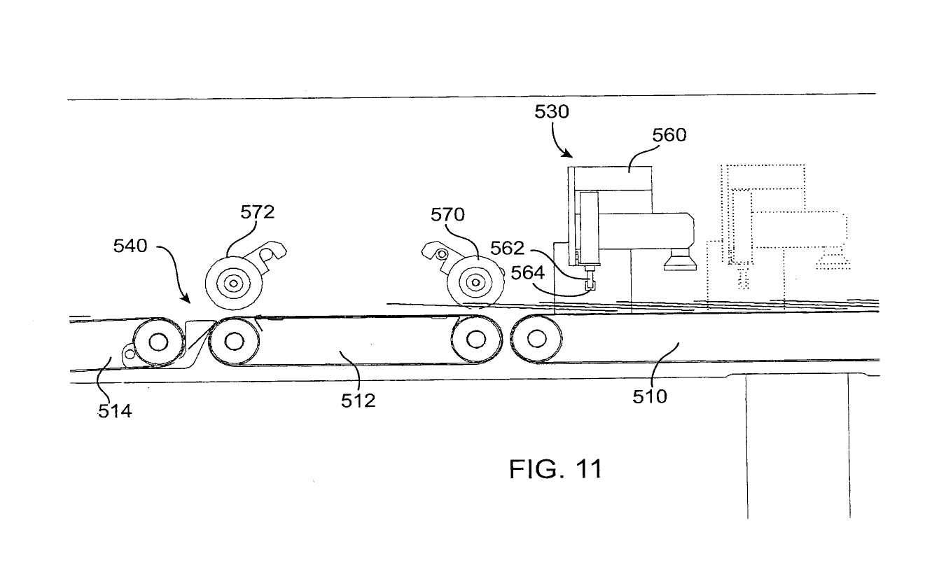

In this example, the interrupter 530 includes a support member 560 that extends across the shingle and interrupt unit 500 in a generally transverse direction; extending across each shingled stream of sheets 24. The support member 560 is movably mounted to the frame of the shingle and interrupt unit 500 so that it can translate in the longitudinal direction, between an upstream or first position (shown in dashed lines, toward the right side of FIG. 11) and downstream or second position. In the current example, the support member 560 is slidably mounted on linear rails and is driven between the upstream and downstream by an interrupter actuator (not shown). The interrupter actuator can be any suitable type of actuator, including, for example an electric servo motor.

The support member 560 is used to support a plurality of page holding mechanisms and one or more interrupt sensors for sensing information relating to one or more of the shingled streams. The page holding mechanisms and the interrupt sensors are mounted to the support member 560 so that they can also translate relative to the frame of the shingle and interrupt unit 500.

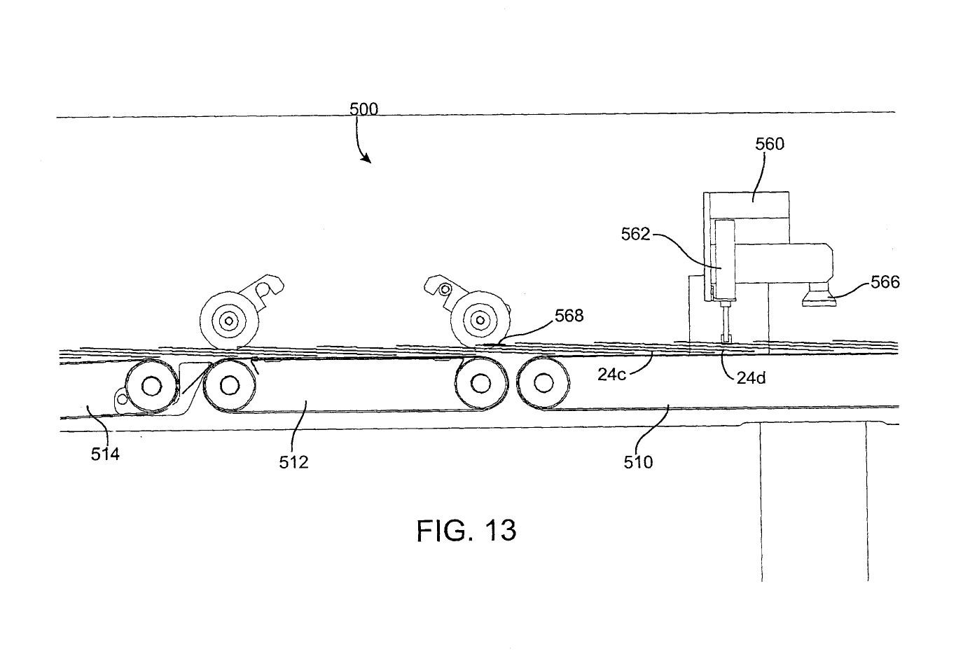

In the present example, the page holding mechanism is a plurality of page holding fingers 562 disposed above each shingled stream. The page holding fingers 562 are moveable between a relaxed or storage position (e.g. FIG. 11) and an engaged position (e.g. FIG. 13). In the storage position, the tips 564 of the fingers 562 are spaced apart from the first conveyor 510, which allows the plurality of sheets 24 to freely pass by the page holding fingers 562 and allows the support member 560 to translate between the downstream and upstream positions without affecting the movement of the sheets 24. In the engage position, the tips 564 of the page holding fingers 562 are driven toward the plurality of sheets 24 (i.e. downward as illustrated) so that each tip 564 contacts a corresponding, predetermined sheet 24 and pinches the sheet 24 against the conveying surface of the first conveyor 510 to inhibit relative movement therebetween. Some or all of the tips 564 can be covered in rubber or other suitable material to enable the tips 564 to enable the page holding fingers 562 to press the designated sheets 24 firmly against the first conveyor 510, while reducing or minimizing damage to the sheets 24 (such as marking, cutting or tearing).

The illustrated page holding fingers 562 are pneumatically actuated pistons that are driven toward the engaged position by selectably applying air pressure in a known manner and are biased to return to the storage position using any suitable biasing means, such as a spring. In other examples, the page holding fingers 562 can be driven in both directions and need not rely on a biasing means to return to the storage position.

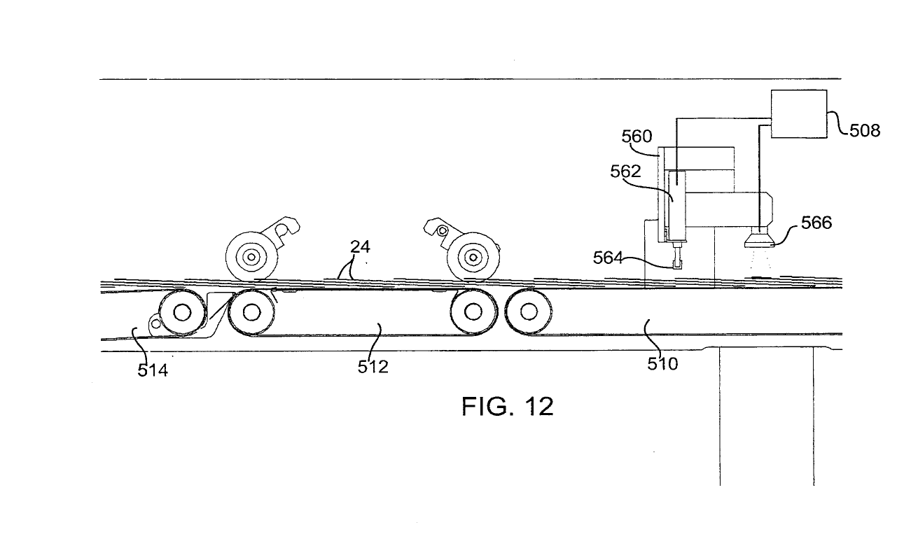

The sensors mounted on the support member 560 can be any suitable type of sensor that can gather the desired information regarding the plurality of sheets 24 forming the shingled streams. In the present example, the sensors are cameras 566 or other optical sensors that are used to detect printed reference marks, for example batch marks 568 (FIG. 12) that are printed on one or more of the sheets 24

In some examples, a separate support member 560 can be provided for each shingled stream, to allow independent movement of the support members 560 based on the specific characteristics of a given shingled stream.

When the shingle and interrupt unit 500 is in use, the singled streams of sheets 24 are advanced in the longitudinal direction using the conveyors 510, 512, 514. A batch mark 568 printed on one of the sheets 24 is sensed by the camera 566. The camera 566 is communicably connected to a shingle and interrupt controller 508, which is configured to receive signals from the camera 566. The batch mark 568 can be any suitable type of reference mark that can be read by a corresponding sensor, including, for example, a stand alone printed feature, a portion of another mark that is sensed at a different step in the process and/or a physical attribute of a sheet (including an edge, hole or other detectable feature).

Based on the information read by the camera 566, the shingle and interrupt controller 508 can calculate the relative position of the sheet 24 that includes the batch mark 568 and the page holding fingers 562. Based on the relative position, and other suitable factors (e.g. including first conveyor speed, sheet length (in the longitudinal direction), etc.) the shingle and interrupt controller 508 determines when to trigger the page holding fingers 562. For example, the batch mark 568 may indicate that the sheet 24 including the batch mark 568 is the final sheet 24c in a given book, and the controller 508 is configured to trigger the page holding fingers 562 so that they engage and pinch the first sheet 24d in the next book.

In addition to triggering the page holding fingers 562, the shingle and interrupt controller 508 controls the movement of the support member 560 and optionally, the speed of the conveyors 510, 512, 514. In such an example, once the page holding fingers 562 are engaged the translation of the support member 560 is synchronized with the speed of the first conveyor 510 so that the page holding fingers 562 remain registered with a particular position on the moving belts of the first conveyor 510. Synchronizing the movement of the support member 560 and the first conveyor 510 allows the page holding fingers 562 to translate in registration with the sheet 24d that is being pinched, which can reduce shear stresses and damage to the sheet 24d.

Pinching the desired sheet, in this example 24d, against the first conveyor 510 also enables the downstream sheets, ending with sheet 24c, to be pulled from beneath and accelerated away from sheet 24d without adjusting or skewing the position of sheet 24d relative to the first conveyor 510 and the plurality of sheets 24 upstream from sheet 24d.

Optionally, while the page holding fingers 562 are engaged, the shingle and interrupt controller 508 can reduce the speed of the first conveyor 510, while maintaining the relative synchronization between the support member 560 and the first conveyor 510.

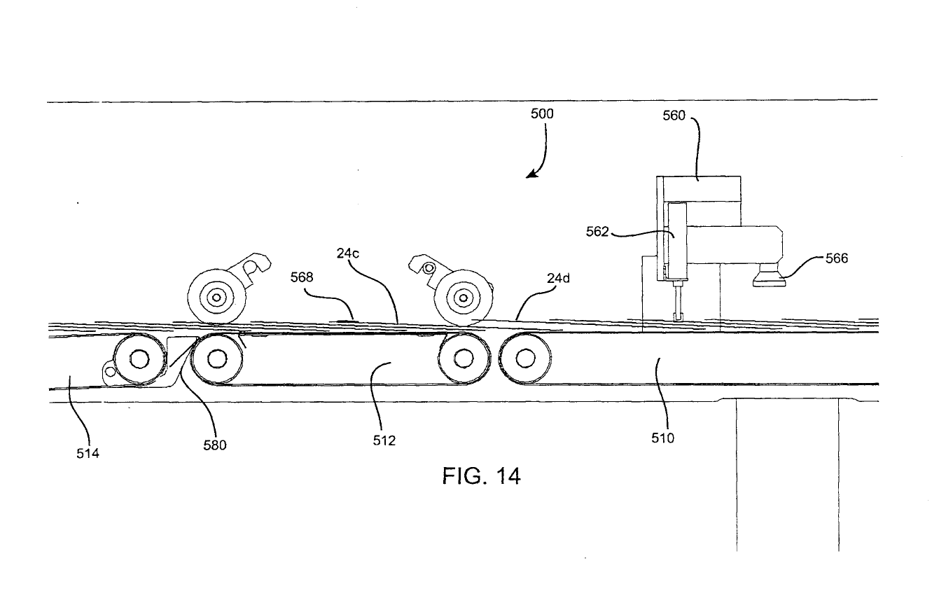

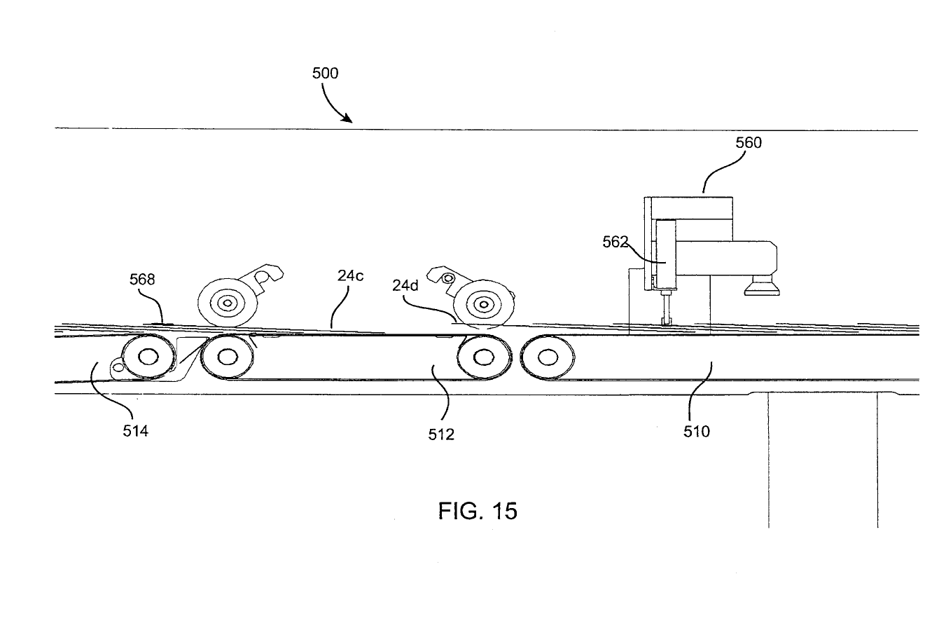

In addition to synchronizing the movement of the support member 560, the shingle and interrupt controller 508 can also increase the speed of the second and third conveyors 512, 514 (by the same amounts or varying amounts) to increase the separation between sheets 24c and 24d, as shown in FIGS. 14 and 15. Increasing the physical separation between sheets 24c and 24d increases the time between the arrivals of sheet 24c and sheet 24d at the batcher unit 600, as described in detail below. In some examples the speeds of the second and third conveyors 512, 514 can be increased between 2-5 times the nominal machine speed (i.e. the speed of the web entering the book block finishing machine 10).

Creating a gap between sheets 24c and 24d allows all of the sheets that form a first book block to advance downstream while the sheets that form a second book block are held upstream, behind pinched sheet 24d. Also, as illustrated, due to the overlap or shingling of the sheets 24, the page holding fingers 562 pressing on sheet 24d will also press on one or more additional upstream sheets that are overlying sheet 24d.

To keep the plurality of sheets 24 in the shingled streams in contact with the conveyors 510, 512, 514 additional rollers or wheels can be provided at the transition zones between conveyors. In the present example, interrupt wheels 570 are provided at the transition between the first and second conveyers 510, 512 to keep the sheets 24 in contact with the second conveyor 512. The friction between the tips 564 of the page holding fingers 562 and the sheets 24 and the pinching force exerted between the page holding fingers 562 and the first conveyor 510 can be set so that they are greater than the frictional force exerted on the sheets 24 by the interrupt wheels 570, so that sheet 24d stays in its desired position until the page holding fingers 562 are disengaged.

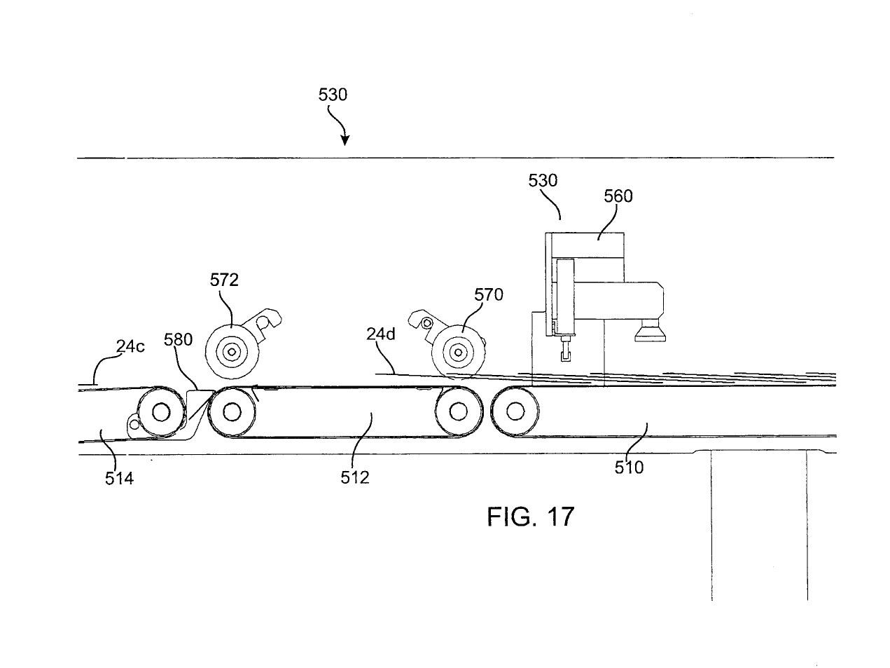

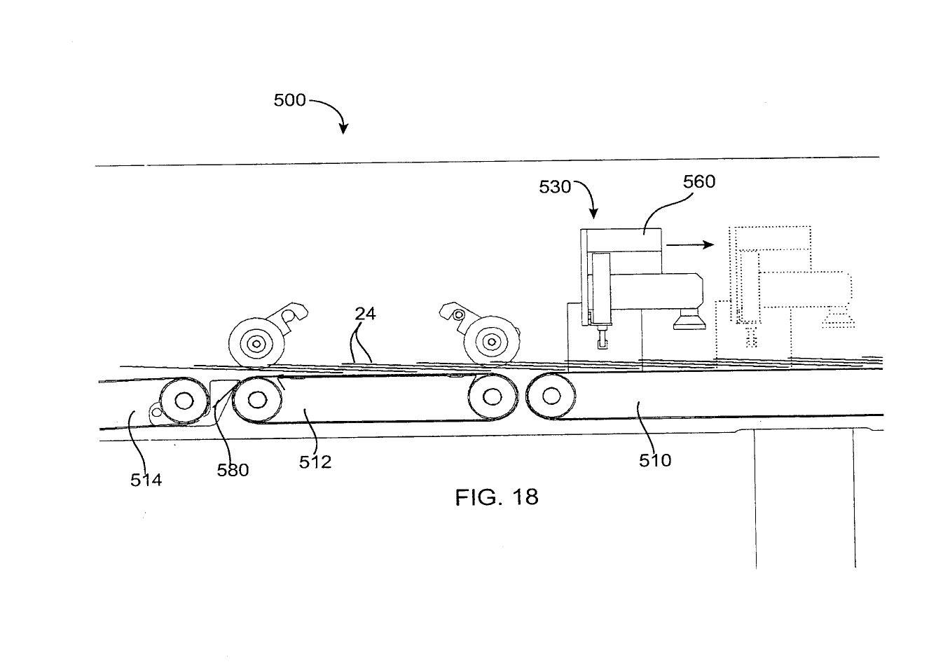

Once the last sheet 24c in the first book block has advanced past a predetermined point (e.g. has reached the third conveyor 514 as shown in FIG. 17), the shingle and interrupt controller 508 can automatically disengage the page holding fingers 562, by cutting of the pneumatic air supply, causing the page holding fingers 564 to return to their storage position and freeing sheet 24d to continue downstream toward the batcher unit 600. With the page holding fingers 562 disengaged, movement of the support member 560 is de-synchronized with the movement of the first conveyor 510 and the support member 560 is returned to its upstream position, as shown by the dotted lines in FIG. 18.

In other examples, the triggering of the page holding mechanism can be done in other suitable ways, including, for example, using a central timing system (i.e. every 400 revolutions of the sheeter knife), manual triggering by a machine operator and triggering based on a pre-determined number of sheets that have passed through the unit (i.e. every 500 sheets).

In some instances, as described above, the shingled streams can include some unwanted or scrap sheets 24 that are not intended to be included in a finished book block. When such sheets are detected, the shingled stream can be interrupted using the page holding fingers 562 and steps described above, to allow the wanted sheets to continue downstream to the batcher unit 600 while holding back the unwanted sheets.

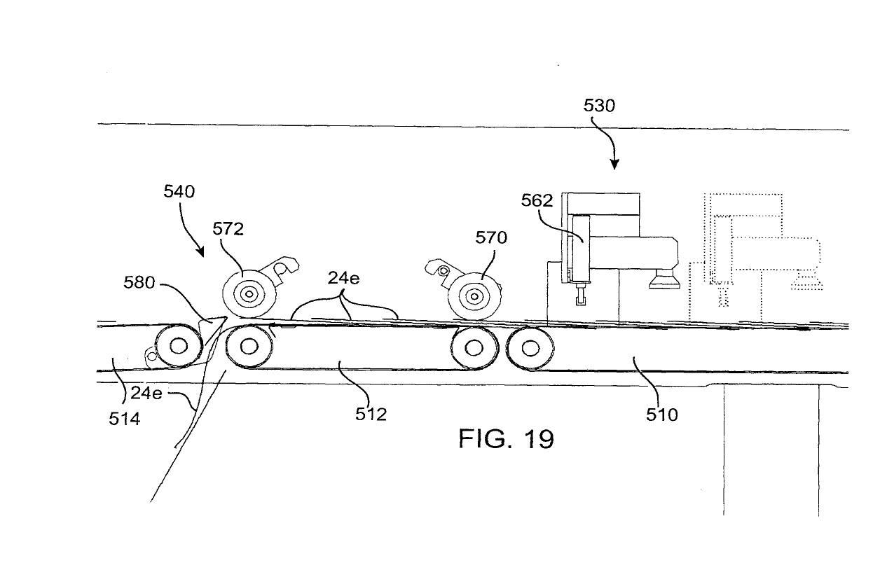

Once the wanted sheets have traveled onto the third conveyor 514, the diverter 540 can be selectably activated to divert the unwanted sheets from the second conveyor 512, as shown in FIG. 19.

In the illustrated example, the diverter 540 includes a deflector 580 located between the second and third conveyors 512, 514. A divert wheel 572 can be provided to help keep the sheets 24 in contact with the second conveyor 512 and to help guide them toward the deflector 580 (instead of lifting off the second conveyor 512 and/or becoming jammed). The deflector 580 is moveable between a first or storage position in which the deflector 580 is recessed below the surfaces of the conveyors 512, 514 (as shown in FIGS. 11-18) and a second or diverting position 580 in which the deflector 580 is raised above the conveying surface of the conveyors 512, 514 to intercept the unwanted sheets, for example sheets 24e, and divert them into a waste stream as the sheets 24e exit the second conveyor 512.

The diverter 540 can also include any suitable type of actuator (not shown) drivingly connected to the deflector 580 that can be used to move the deflector 580 between its storage and divert positions. Like other features of the shingle and interrupt unit 500, the diverter 540 can be communicably linked to the shingle and interrupt controller 508 so that it can be automatically controlled, or it can be configured to be triggered manually by a machine operator.

To un-divert the shingled streams (i.e. to stop diverting sheets to a waste stream when the next book block starts) the above steps are repeated. Specifically, flow of the singled streams is interrupted using the interrupter 530 and modifying the relative speed of the second conveyor 512 to create a gap between the last, unwanted sheet and the first, wanted sheet that forms part of the next book block.

When the gap reaches the deflector 580 (i.e. when the last unwanted sheet has been diverted to waste but before the first, wanted sheet has reached the end of the second conveyor 512) the deflector 580 is dropped from its divert position to its storage position, thereby allowing the stream of wanted sheets to travel from the second conveyor 512 to the third conveyor 514.

Using this example of the interrupt and divert unit 500, the first conveyor 510 can be operated at a constant speed throughout the operation of the book lock finishing machine 10, because sufficient gaps (for example, gaps that allow the clamping and binding of a first book block before sheets of the second book block arrive at the batcher unit 600 and/or gaps that allow unwanted sheets 24e to be isolated and diverted without affecting the preceding or following, wanted sheets) in the shingled streams of sheets 24 can be created using the interrupter 530 and by varying the operating speeds of the second and third conveyors 512, 514.

Optionally, the third conveyor 514 can be pivotally mounted to the frame of the shingle and interrupt unit 500 so that the vertical position of the downstream end of the third conveyor 514 (i.e. the end proximate the batcher unit 600) can be adjusted. In some examples, the vertical position, or height, of the downstream end of the third conveyor 514 can be adjusted to alter the vertical distance between the downstream end of the conveyor 514 and the floor or lower support surface of the hoppers in the batcher unit (described below). The position of the downstream end of the third conveyor 514 can be adjustable between a first or level position, in which the third conveyor 514 is generally horizontal and the downstream end is on the same horizontal plane as the upstream end, and a maximum declined position, in which the downstream end of the third conveyor 514 is lowered below the elevation of the upstream end, so the third conveyor 514 is generally sloped toward the batcher unit 600. The third conveyor 514 can be continuously adjustable between the level and maximum declined positions (being fixable in a plurality of intermediate positions therebetween) or it can be indexed to move between two or more set positions.

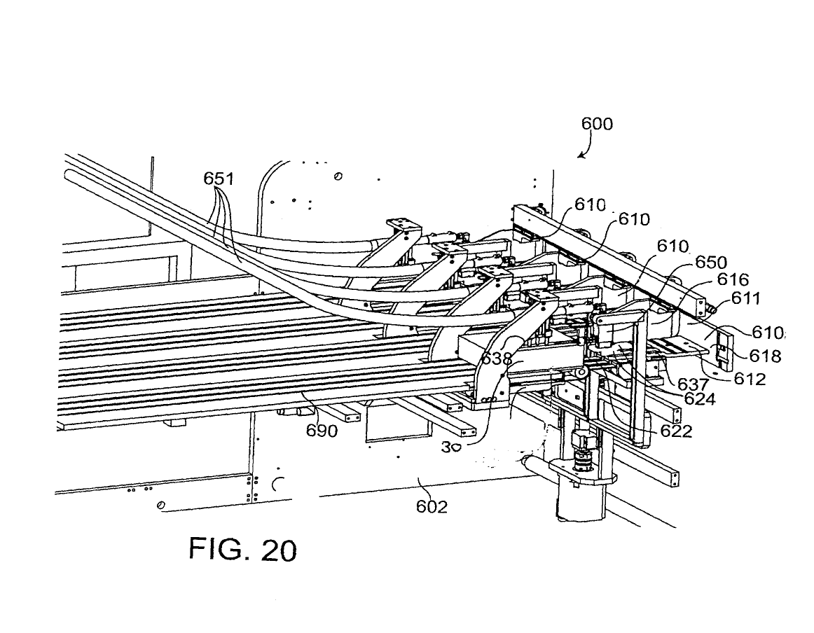

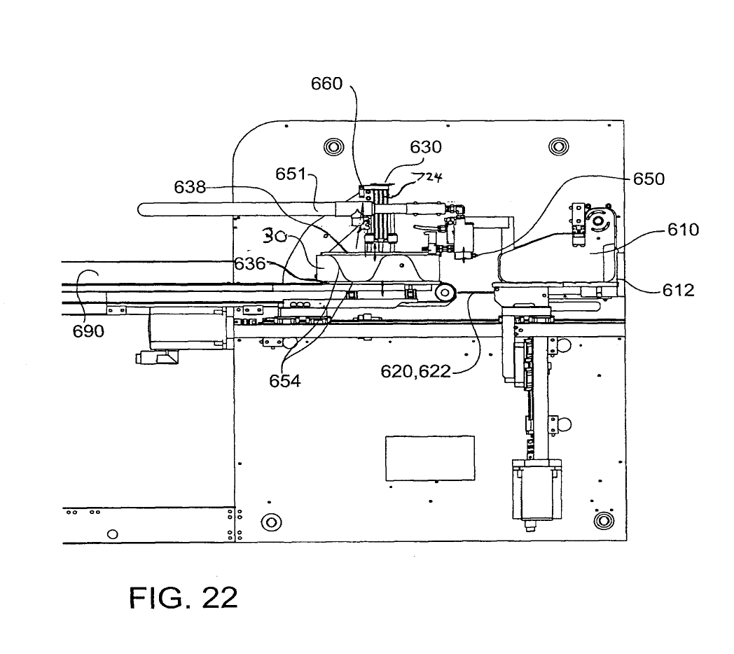

Individual sheets passing through the shingle and interrupt unit 500 then flow into a batcher unit, an example of batcher unit 600 is illustrated in FIGS. 20-22. The batcher unit 600 includes a plurality of batch hoppers 610 within which a plurality of sheets 24 for a given print job (i.e. a single copy of the book being printed) are stacked to create a book block 30 having the desired number of pages of the finished product (optionally ranging from a few sheets to several hundred pages). The batcher unit 600 also includes a shuttle 630 and a moveable adhesive applicator, for example glue head 650, for each hopper 610. In other examples, the batcher unit 600 can include a different number of adhesive applicators, for example a single adhesive applicator could be moveable such that it could be used to provide glue on multiple book blocks (as described below).

During a batching sequence or batching cycle (i.e. the cycle of making one completed book block) the desired number of sheets 24 are fed from the shingle and interrupt unit 500 into one of the hoppers 610 of the batcher unit 600. Each stream of sheets generally flows or feeds into a corresponding hopper 610. The present example of the batcher unit 600 is illustrated having four hoppers 610, for receiving up to four streams of sheets 24 formed from up to eight ribbon 22 streams (some or all of the streams of sheets 24 being stacked ribbon streams). It is understood that other examples of the batcher unit 600 may include a greater or fewer number of hoppers 610 (and related hardware described in detail below).

Each hopper 610 includes an interior volume 611 defined by a bottom support, for example bottom 612, a moveable side wall 614, a fixed sidewall 616, a rear support, for example a fixed upstream end wall 618 and a moveable gate 620 forming the downstream end of the hopper. The fixed sidewall 616 of each hopper 610 is aligned with one of the reference positions 250a-d to which the ribbon streams were justified by the ribbon shifting unit 200. Aligning the reference positions 250a-d with the locations of the fixed side walls 616 allows for each stream to be accurately received within its corresponding hopper 610 as both the stream reference edge 24 and the hopper 610 fixed side wall 616 are aligned with a corresponding reference position 250a-d.

Within each batch hopper 610, as the individual sheets 24 are fed into the hopper 610 the sheets are vibrated (or jogged) by oscillating a side jogger, for example the movable side wall 614 at a relatively high frequency or other known jogging techniques to create aligned book blocks 30, and so that the completed book blocks 30 are registered or justified to one side of the hopper 610 (generally against the fixed side wall 616). Also, the movement of the moveable side wall 614 can be programmable to operate differently as the book block is created. For example the movable side wall 614 may oscillate in a slightly open setting (i.e. centered about a position that is slightly wider than transverse the width of the expected book block) so as to not pinch the sheets 24 are flowing into the hopper 610. Once all the sheets 24 that make up a given book block are in the hopper 610 and the flow is interrupted, the movable side wall 614 can shift inward and oscillate tighter against the book block to perform a final jog to even up book block edges.

The present batcher unit 600 may include several hoppers 610 operating in parallel with each hopper 610 accepting the sheets 24 from a given ribbon 22, and the book blocks 30 within each hopper may be justified in the same manner (i.e. to the right side in every hopper 610). By adjusting the range of movement of the moveable side wall 614 and the longitudinal position of the gate 620 each hopper 610 can be reconfigured on the fly to accommodate book blocks 30 of differing length, width and page number.

After all the sheets 24 of a book are stacked in the hopper 610 they are considered to have formed a stack or book block 30. The incoming sheet stream is interrupted or arrested to stop any additional sheets 24 from flowing into the hopper 610. When the book block 30 is completed it is clamped by the upper and lower clamp plates 638, 636 of a movable shuttle 630. The floor 612 of each hopper 610 includes a slot 637 for receiving the lower clamp 636 of the corresponding shuttle 630.

To clamp the book block 30 both clamp plates 636, 638 move from their respective first or retracted positions to their second or extended positions (or clamped positions). The retracted position of the lower clamp 636 is lower than the floor 612 of the hopper 610 and the extended position of the lower clamp 636 is proud of the floor 612 of the hopper 610 so that the lower clamp 636 can be moved into the slot below the book block 30 without disturbing the bottom sheet of the book block 30 and, when the lower clamp plate 636 is extended it lifts the book block 30 proud of the floor 612 of the hopper 610 so that the book block 30 can be moved relative to the hopper 610 without damaging or jarring the bottom sheet of the book block 30. To ensure that the book block 30 is lifted proud of the hopper floor 612, the clamping force of the lower clamp 636 may be greater than the clamping force of the upper clamp 638. Optionally, the clamp plates 636, 638 are positioned slightly inward from the clamped edge of the book block 30 to reduce the chances of adhesive contacting the clamp plates or other interference issues.

Once the clamp plates 636, 638 have engaged the book block 30, the hopper gate 620 is opened and the shuttles 630 can be moved in the downstream direction, carrying the book blocks 30 out of the hoppers 610. The shuttles 630 may be moved using any suitable actuator including hydraulic and pneumatic cylinders, ball screws, gears, chain drives and belt drives (not shown).

In some examples all the shuttles 630 may move in unison, in other examples each shuttle or a sub-group of shuttles may be moveable independently of the other shuttles. Also, the clamping mechanism has been described as comprising upper and lower clamp plates 638, 636 but it is understood that any suitable clamping mechanism could be used, including variations of the clamp plates having different shapes and sizes and being applied with different forces. The clamping force may be generated using any known means, including hydraulic and pneumatic pressure and mechanical actuators, including actuator 724. Motion and activation of the shuttle 620 and the clamp plates 636, 638 may be controlled by the batcher unit controller or computer and may be based on sensor information.

In the present example, the hopper gate 620 may pivot in a downstream direction to allow the book block 30 to pass over the gate 620 as it exits the hopper 610 and the gate 620 may provide some support for the book block 30 as it moves. In other examples the gate 620 may be slidingly or rotationally connected or may pivot in a direction other than downstream. The gate 620 may be operated by servo motor, electric actuator, pneumatic actuator or other suitable actuator. Further, in the example shown the gate 620 for each hopper 610 includes a plurality of gate fingers 622 received in gate grooves 624 in the floor 612 of each hopper 610. Configuring the gate 620 as a plurality of gate fingers 622 spaced apart across the width of the hopper 610 allows each gate 620 to be operated using all gate fingers 622 for large book blocks 30, or only a portion of the gate fingers 622 when producing narrower book blocks 30. Such a configuration may allow the shuttle 630 and moveable side wall 614 to adjust to produce smaller, narrower book blocks 30 without interfering with or colliding with unneeded portions of a single, unitary gate. However, some examples of the book block finishing machine 10 the gate 620 may be a single gate member. Optionally, the longitudinal position of the gate 620 may be adjustable relative to the walls of the hopper 610 so that the gate 620 (which provides the downstream stop position for sheets 24 received in the hopper 610) can be re-positioned to receive pages of different lengths within the hopper 610.

When the gate 620 on the hopper 610 is opened, the completed book block 30 is clamped to remove air from the book block (as described above) and measured to verify the height/thickness of the finished book using the height sensor 660. The shuttle 630 is then translated downstream, past the glue nozzle 650, until the book block 30 is clear of the hopper 610. Once the clamped book block 30 is clear of the hopper the end gate 620 of the hopper 610 can be closed, the incoming stream of sheets can be resumed (the interrupter or the arrester are released) and a new set of sheets 24 can be stacked within the hopper 610 while the clamped book block 30 is further processed. This may improve the efficiency (reduce the cycle time) of the batching process.

In some examples of the book block finishing machine 10 both side walls 614, 616 of the hoppers 610 may be movable so that the hoppers 610 can be configured to receive sheets of different widths or to allow greater spacing between reference positions 250a-d. In some examples (when all ribbons are registered to each other) the hoppers 610 and shuttles 630 may be configured together in the same configuration. In other examples (where each ribbon is not registered to its adjacent ribbon(s), each hopper 610 and shuttle 630 may be independently configurable.

Upon leaving its hopper 610, each book block 30 held within the clamp plates 636, 638 of its shuttle 630 is translated past a gluing station where glue is applied to a binding edge of the book block 30 (for example on the book spine) by a moveable glue nozzle 650. Applying glue at this stage in the book manufacturing process may provide the means to secure or bind the book block 30, keeping it intact for further handling.

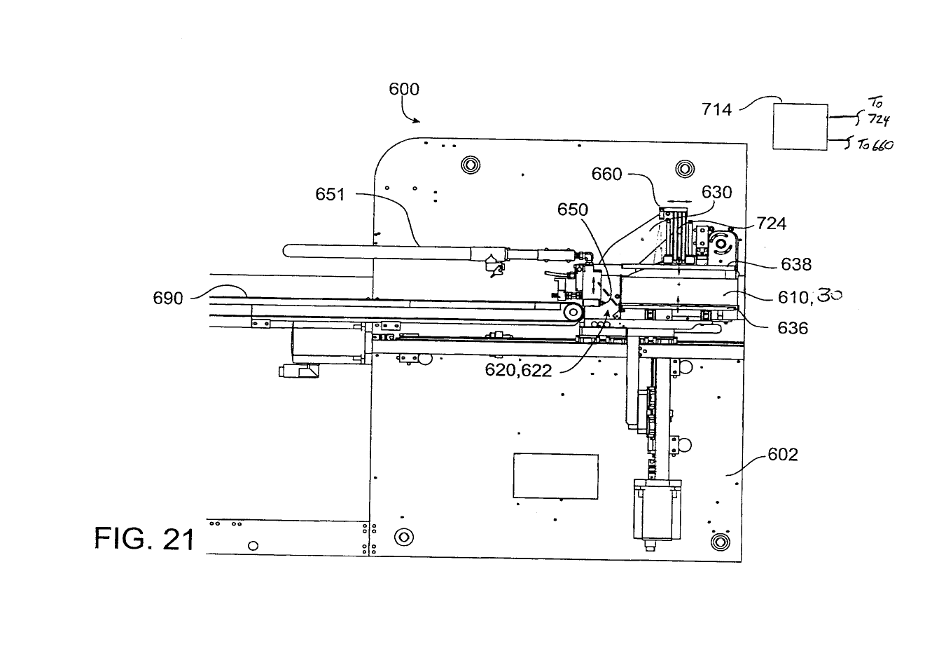

To apply the glue the batcher unit 600 is configured to impart relative movement between the book block 30 and the glue applicator, in this example the glue head 650. In the described examples the clamped book block 30 is advanced horizontally translated past the movable glue nozzle 650 and as the book block 30 moves past the glue nozzle 650 (e.g. horizontally) the glue nozzle 650 translates in a direction orthogonal to the book block movement (e.g. vertically). The resulting combination of horizontal and vertical movement of the book block 30 and the glue nozzle 650 respectively produces a bead of adhesive 654 that traces a path across the edge of the book block 30. In some examples the path may resemble a sine curve, and in other examples the relative speeds of the book block 30 and the glue nozzle 650 can be adjusted so that the adhesive bead traces a modified sine curve pattern having extended pauses at the peaks in order to apply extra adhesive to the top and bottom pages in the book block 30, as shown in FIG. 21. The shuttle 630, clamp plates 636, 638 and glue nozzles 650 are communicably connected to a batcher unit controller 714 that can automatically control the operation of these elements in the manner described above. Like other controllers disclosed herein, the batcher unit controller 714 can be a combination of both hardware and software and can be configured as a stand-alone controller or integrated as a module in another controller.

The range of motion of the glue nozzle 650 is adjustable and can be set based on the dimensions of the book being printed and the height information obtained using height sensor 660. Determining the height of a clamped book block 30 using the height sensor 660 (acoustic, or laser or any other suitable sensor) may be advantageous as it can be used to calculate a motion profile for the shuttle 630 and glue nozzle 650 which may limit the vertical travel of the glue nozzle 650 which may in turn reduce waste and may prevent the glue nozzle 650 from apply glue to unwanted area of the book block 30. The height sensor 660 can also be connected to the batcher unit controller 714.

This combination of book block translation and adjustable glue nozzle 650 translation allows the glue nozzle to easily and quickly adapt to different book block 30 sizes on the fly, which may not be possible using a traditional fixed nozzle or slotted extrusion type glue nozzle.

Glue/adhesive can be stored within the glue head 650 or supplied from an external source (not shown) by a glue supply line 651.

Once the glue is set the clamp plates 636, 638 can release the book block 30 onto a book block conveyor, for example conveyor belt 690. The resilient properties of the glue may serve to keep the book block 30 intact during transport while still allowing the flexibility required for subsequent handling and processing. The glued book block is then moved down a conveyor belt 690 for further processing. In the present example, the adhesive applied to the book block 30 in the batcher unit 600 is a temporary adhesive that is not intended to remain on the final product.

The adhesive applied to the book blocks 30 by the batcher unit 600 can be described as a temporary adhesive because in some examples it is not intended to remain on the book block 30 after the book block 30 has been covered and bound as a finished book. In such example, the edge of the book block 30 that has been treated with adhesive is subsequently trimmed or shaved off prior to binding the book block 30 into a finished book. That is, in some examples, before the book block 30 is bound with its finishing cover the glued edge may be trimmed off to provide a clean, straight edge for attachment to the book spine. In these examples, the term temporary adhesive is understood to mean an adhesive that is applied to the book blocks 30 to help stabilize them during subsequent processing but that is removed (by trimming or any other method) prior to attaching a cover to the book block 30.

In other examples, the spine or cover may be attached over the existing glued edge.

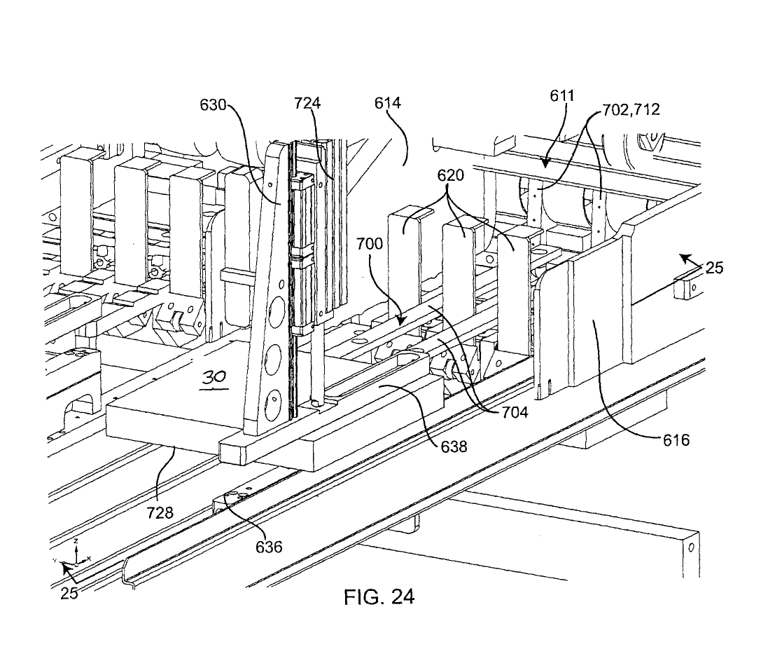

Referring to FIGS. 24-26, another example of a batcher unit 600 includes hoppers 610 having interior volumes 611 for receiving a plurality of sheets 24. In this example, each interior volume is defined by a moveable side wall 614, fixed sidewall 616, a bottom support 700 a rear support 702 and a moveable gate 620 that provides the downstream end of the hoppers 610.

In this example, the bottom support 700 that supports the plurality of sheets 24 received within the hopper 610 includes a pair of spaced apart support members or rails 704 and the lower clamp plate 636. In this example the lower clamp 636 is not extendible or moveable relative to the moveable shuttle 630. Using the rails 704 and lower clamp plate 636 to support the stacked sheets, i.e. the book blocks, within the hopper 610 eliminates the need to include a solid bottom wall or floor on each hopper 610. Optionally, the rails 704 can be positioned at a slightly higher elevation than the lower clamp plate 636 so the sheets 24 received in the hopper 610 define a slightly curved or arcuate profile in the transverse direction. Such a curved profile in stacked sheets can increase the rigidity of the sheets which may be helpful when handling light weight papers.

Like the example described above, as the plurality of sheets 24 are fed into the hopper 610 they can be jogged by oscillating the moveable side wall 614.

In addition to eliminating the need for a solid hopper floor, the present example also includes a rear support 702 that is formed from a plurality of pivotable, oscillating support fingers 712, defining a rear jogger, that can jog the book blocks in the longitudinal direction. While the illustrated example includes two support fingers 712 per hopper 610, it is understood that any number of fingers could be used, and optionally that individual fingers could be replaced with a solid plate if desired. Providing an oscillating rear support 702 enables the hoppers 610 to jog the book blocks in both the longitudinal and transverse directions, which can help create even, smooth surfaces on each side of the book block.

The hoppers 610 can also be configured to include a nozzle 716 that is configured to supply air (or any other suitable fluid from a fluid supply—not shown) into the hopper 610 as the sheets 24 are fed into the hopper 610. Providing a supply of air between the sheets 24 can inhibit interference between sequential sheets 24 and reduce the chances of jamming, binding or misalignment between sequential sheets 24 and may enable subsequent sheets to float or gently settle onto the preceding sheets retained in the hopper. Optionally, the air can be ionized to reduce the build-up of static charge between sheets 24. The nozzle can be configured to continuously supply a steady stream of air, or to provide separate puffs of air that are synchronized with the movement of the sheets 24.

In this example, the lower clamp plate 636 is a stationary member that is fixedly connected to the moveable shuttle 630. The lower clamp plate 636 does not move between retracted and extended positions. In this example, the lower clamp plate 636 is positioned so that it is at a desired level relative to the rails 704 and ledge 706 and remains in this position until adjusted by a machine operator. Optionally, the lower clamp plate 636 is formed from two separate members, 636a and 636b that can be adjusted relative to each other. This relative adjustment allows an upper surface of member 636a to be leveled (i.e. arranged horizontally) and positioned at an optimal elevation without requiring the adjustment of member 636b or other portions of the shuttle 630 or batcher unit 600.

The shuttle 630 includes an upper frame member 720 that is connected to a lower frame member 722. Optionally, the upper and lower frame members 720, 722 can be a single continuous member. The lower frame member 722 is slidably or translatably mounted to the frame 602 of the batcher unit 600, for example on a plurality of parallel rails 601. The lower frame 722 can be connected to the rails 601 using any suitable means.

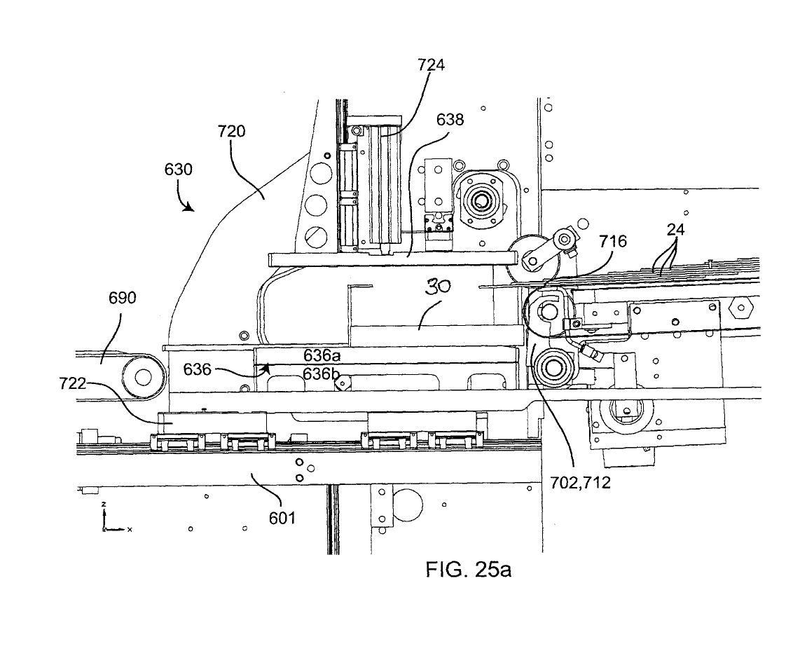

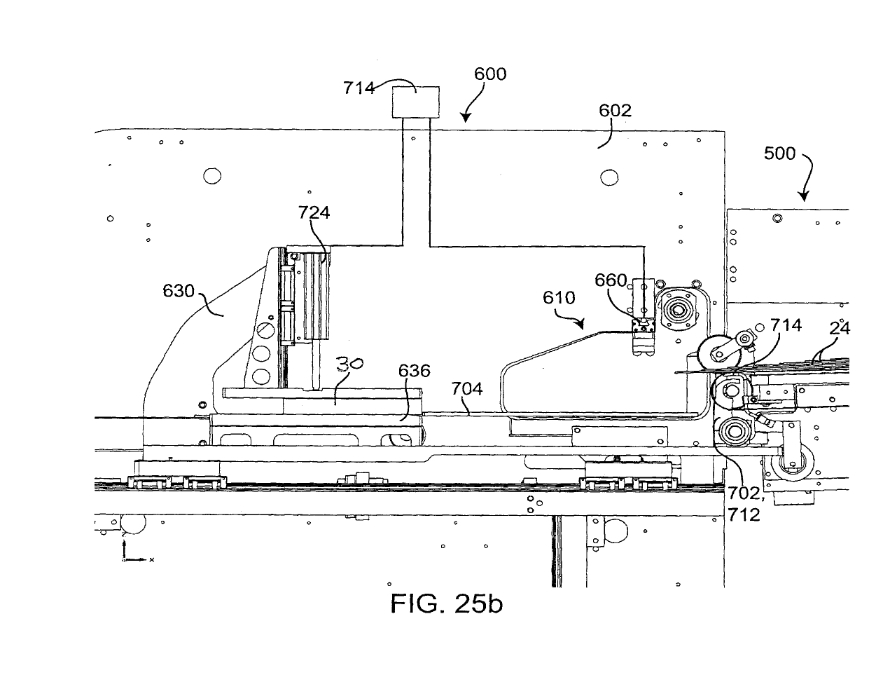

The upper frame member 720 can be curved as shown, or any other suitable shape that enables the upper clamp plate 638 to be positioned in the desired location. The upper frame member 720 also supports the upper clamp plate 638 and a clamp actuator 724 that is used to move the upper clamp plate 638 between its retracted position (as shown in FIG. 25a) and its extended position (as shown in FIG. 25b). In this configuration, the clamp actuator 724 is translateable with the shuttle 620, between the upstream (as shown in FIG. 25a) and downstream (as shown in FIGS. 24 and 25b) positions. Each clamp actuator 724 can be connected to the batcher unit controller 714 so that each clamp can be trigger automatically based on any suitable criteria, including, for example, book block height data received from height sensor 660. In other examples, the clamp actuator 724 and shuttle 630 can be automatically triggered after a certain number of sheets 24 have entered the hopper 610, or after a certain time has passed (i.e. once every 5 seconds).

As mentioned above, in the present example the shuttle 630 is a single member that extends across the transverse width of the batcher unit 600. The shuttle 630 can include any suitable number of upper frame members 720 and can support any suitable number of clamp actuators 724 and upper clamp plates 638, for example one of each per hopper 610.

Optionally, the hopper gates 620 can be translatable in the transverse direction so that they are generally aligned with the centre of the particular book blocks being formed by the batcher unit 600. For example, if the book blocks 30 being formed have a transverse width 726 of 4 inches, the hopper gate 620 can be positioned so that it is centered 2 inches from the fixed side wall 616, which is aligned with a given reference position 250a-d. If the next book block 30 to be formed by the batcher unit 600 has a width 726 of 10 inches, the hopper gate 620 can be translated so that it is centered 5 inches from the fixed side wall 616.

The movement of the hopper gates 620 can be related to the movement of the moveable side walls 614 (which are also repositioned to accommodate book blocks of differing widths) or the hopper gates 620 can be moved independent of the moveable side walls 614. Movement of the hopper gates 620 can be automatically controlled by the batcher unit controller.

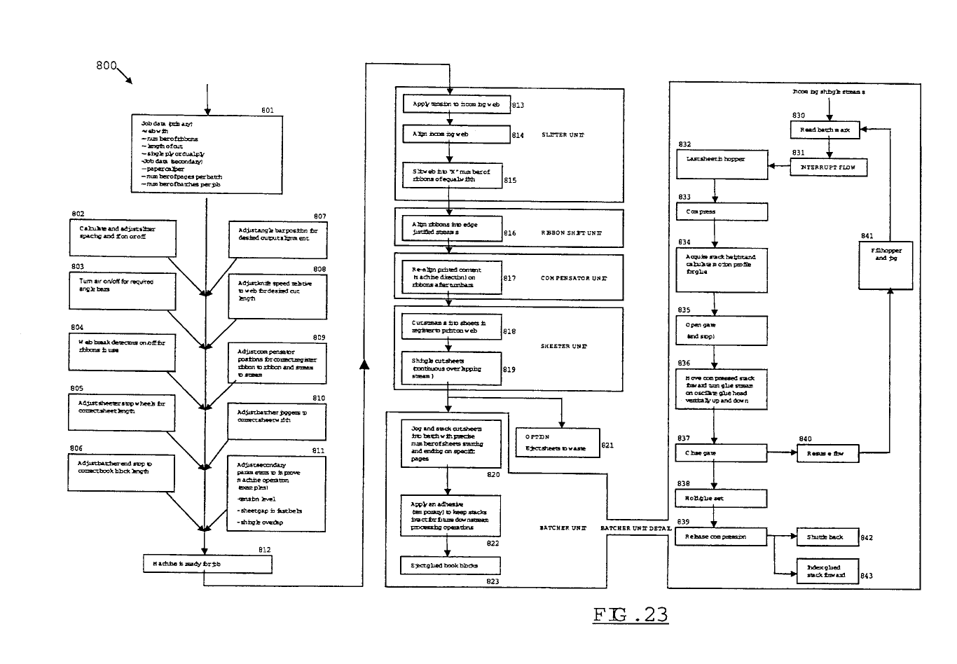

Referring now to FIG. 23, one example of a production process 800 to produce book blocks using a book block finishing machine is illustrated with a flow chart. The process 800 begins with the receipt of primary and secondary job data at step 801. This job data may be used to configure various aspects of the book block finishing machine and the production process 800.

After having received the job data, the process advances to step 812 by completing intermediate steps 802-811 in any desired sequence, not necessarily according to the order of the reference numerals provided for ease of reference only. For example, step 802 is adjusting the slitting unit as described above while step 803 relates to supply air to the turn bars for air lubrication. Both of these steps must be performed, or not, prior to running the book block finishing machine, but the performance of step 803 does not depend on the performance of step 802.

Step 804 relates to checking the integrity of the incoming web to and ribbons to detect breaks. Step 805 relates to adjusting the sheeter unit to properly handle the desired frame length/page length of the product being produced. Step 806 relates to the downstream positioning of the gate in each hopper to accommodate pages/frames of different lengths in each hopper. Step 807 relates to positioning the turn bars in the ribbon shifting unit to properly align the output ribbons. Step 808 relates to adjusting the compensator to correctly register adjacent ribbons. Step 809 relates to adjusting the operation of the slitter knife to properly cut the incoming ribbons. Step 810 relates to adjusting the joggers within each hopper. Step 811 relates to adjusting a variety of secondary parameters including machine web tension, sheet gap in fast belts and shingle overlap. Once steps 802-811 have been considered (whether action was required or not) the machine is ready to run and the process has advanced to step 812.

At step 813 the tension of the incoming web is set to the desired operating level. At step 812 the incoming web is aligned to its desired operating position and at step 815 the incoming web is passed through the slitters and longitudinally slit into a predetermined number of ribbons.

At step 816 the ribbons leave the slitting unit and are received in the ribbon shifting unit where each ribbon is engaged by a turn bar and the reference edge of each ribbon is aligned with the appropriate reference position.

At step 817 the shifted ribbons are fed from the ribbon shifting unit into the compensator unit where the ribbons are re-registered to the positions they had when they formed the continuous incoming web.

After being registered at step 817, the ribbons are cut into individual sheets by the sheeter unit at step 818. The individual sheets are then arranged into a shingled configuration at step 819.

Optionally, step 821 may be executed prior to step 820 in order for excess or waste sheets to be diverted out of the process stream prior to entering the batcher unit. After the sheets have been diverted, or if no sheets are to be diverted, the process proceeds to step 820 in which the individual sheets are received within a hopper in the batcher unit, jogged into alignment formed into a book block. After being formed into a book block at step 821a temporary adhesive is applied to the book block to keep each book block/stack intact for further processing downstream. After the adhesive is set, the process concludes with step 823 in which the glued book block is ejected from the batcher unit and conveyed away for further processing.

Additional detail and sub-steps of process steps 820, 822, 823 is provided by steps 830-843 on the right side of FIG. 13. At step 830 a batch mark on an incoming shingled stream is read using a sensor. Based on the information from step 830, at step 831 the flow of sheets is interrupted at a desired location. After the flow has been interrupted, in any suitable manner including those described above, the process continues until the last non-interrupted sheet has been received in the hopper at step 832.

Once the last sheet is received in the hopper, the stack of sheets is jogged as described above and then clamped at step 833 to compress the stack. At step 834, the height of compressed stack is acquired and used to calculate a motion profile for the gluing operation.

At step 835 the downstream gate of the hopper is opened to allow the clamped book block to exit the hopper. At step 836 as the compressed book block is advanced forward past the glue nozzle, the glue flow is turned on and the glue nozzle is oscillated vertically.

Once the book block is clear of the hopper gate the gate is returned to its closed position at step 837, the incoming flow of sheets is resumed at step 840, the hopper is re-filled and jogged at step 841 and the process then repeats steps 830-837 until no additional book blocks are to be created.

Independent of steps 840 and 841 the glued book block is held at step 838 until the glue has dried or set, at which point the process proceeds to step 839 in which the glued book block is released from the clamp and conveyed away. At step 842 the shuttle returns to its starting position and at step 843 the glue nozzle returns to its staring position, ready to process the next book block.

It is understood that elements and features of each of the examples described herein can be used in combination or sub-combination with the elements and features of any other example described herein, unless expressly stated to the contray. For example, it is understood that any given book block finishing machine may include either version of the batcher unit 600 described herein in combination with any version or example of the shingle and interrupt unit 500 and in combination with any version or example of the compensator unit 300.

It is also understood that any unit described herein can include any combination of features described in any one of the examples listed above. For example, any given shingle and interrupt unit may include any suitable combination of diverter (i.e. deflector or conveyor) and interrupter (e.g. page holding fingers or arrester) and any suitable combination of conveyors (e.g. two or three conveyors).

What has been described above has been intended to be illustrative of the invention and non-limiting and it will be understood by persons skilled in the art that other variants and modifications may be made without departing from the scope of the invention as defined in the claims appended hereto.

1. A method of assembling book blocks, the method comprising:
a) receiving a continuous printed web;
b) separating the web into a plurality of sheets;
c) stacking the plurality of sheets in a hopper to form a book block;
d) applying adhesive to at least one edge of the book block so that the plurality of sheets forming the book block are bound together.

2. The method of claim 1, further comprising clamping the book block to inhibit relative movement between the plurality of sheets forming the book block while applying the adhesive.

3. The method of claim 1, further comprising moving the book block while applying the adhesive.

4. The method of claim 1, wherein the adhesive is applied using an adhesive applicator and further comprising imparting relative movement between the book block and the adhesive applicator while applying the adhesive.

5. The method of claim 4, further comprising moving one of the book block and the adhesive applicator in a first direction while applying the adhesive.

6. The method of claim 5, further comprising simultaneously moving the one of the book block and the adhesive applicator in a second direction while applying the adhesive so that the adhesive traces a patch across the edge of the book block.

7. The method of claim 5, further comprising simultaneously moving the other of the book block and the adhesive applicator in a second direction while applying the adhesive so that the adhesive traces a patch across the edge of the book block.

8. The method of claim 7, wherein the book block is translatable in the first direction and the adhesive applicator is translatable in the second direction, the second direction being generally orthogonal to the first direction.

9. The method of claim 8, further comprising oscillating the adhesive applicator in the second direction while applying the adhesive.

10. The method of claim 9, further comprising oscillating the adhesive applicator in a consistent, predetermined frequency so that the path traced by the adhesive is generally sinusoidal.

11. The method of claim 1, wherein step b) further comprises the steps of
e) separating the web into at least two ribbons,
f) aligning the at least two ribbons relative to each other; and
g) simultaneously cutting each ribbon to form the plurality of sheets.

12. (canceled)

13. (canceled)

14. The method of claim 1, further comprising identifying selected ones of the sheets created in step (b) and diverting the selected ones of the plurality of sheets to prevent the selected ones of the plurality of sheets from entering the hopper.

15. A book block finishing machine comprising:
a forming unit to receive a printed web;
a sheeting unit downstream from the forming unit to receive the web and to separate the web into at least one plurality of sheets; and
a batcher unit comprising at least one hopper to receive and stack each plurality of sheets to form at least one book block, the batcher unit further comprising at least one adhesive applicator, each adhesive applicator operable to apply adhesive to at least one edge of each book block to bind together the plurality of sheets forming each book block.

16. The book block finishing machine of claim 15, wherein the batcher unit further comprises at least one clamp to selectably clamp each book block while the adhesive is being applied.

17. The book block finishing machine of claim 16, wherein at least one of the at least one clamp and the at least one adhesive applicator is moveable relative to the other to impart relative movement between each clamped book block and the at least one adhesive applicator while the adhesive is being applied.

18. The book block finishing machine of claim 17, wherein each clamp is moveable in a first direction while the adhesive is being applied to move each clamped book block from an upstream position to a downstream position past the at least one adhesive applicator.

19-20. (canceled)

21. The book block finishing machine of claim 18, wherein each adhesive applicator is operable to apply a bead of adhesive to the at least one edge of the book block and each adhesive applicator is movable between first and second positions along a second direction and, the second direction being at an angle to the first direction.

22. The book block finishing machine of claim 21, wherein each adhesive applicator can oscillate between its first and second positions as the clamp moves from the upstream position to the downstream position so that the bead of adhesive defines a predetermined path along the edge of the book block.

23-27. (canceled)

28. The book block finishing machine of claim 15, wherein each hopper comprises a gate at a downstream end thereof, the gate is movable between a closed position, in which the book block is retained within the hopper, and an open position, in which the book block can be removed from the hopper.

29. (canceled)

30. The book block finishing machine of claim 15, wherein each hopper further comprises opposing first and second sidewalls, each first sidewall is moveable in a transverse direction relative its corresponding second sidewall to accommodate book blocks of different book block widths.

31. (canceled)

32. The book block finishing machine of claim 15, wherein each hopper comprises a rear support that defines a rear jogger that can oscillate to jog the plurality of sheets entering each hopper in a machine direction.

33. The book block finishing machine of claim 15, further comprising an air nozzle directed into each hopper to introduce an air flow between sequential ones of the plurality of sheets entering each hopper to inhibit interference between sequential sheets.

34. The book block finishing machine of claim 15, further comprising a shingle and interrupt unit to receive each plurality of sheets from the sheeting unit and at least partially overlap adjacent sheets to form corresponding shingled streams traveling in a machine direction.

35-46. (canceled)

47. The book block finishing machine of claim 15, wherein the forming unit comprises a slitting unit that has an infeed unit to receive the printed web and a slitter assembly downstream from the infeed unit to separate the web into at least two ribbons, the slitter assembly comprises a plurality of slitters opposing a corresponding plurality of anvil surfaces, each slitter being offset from its corresponding anvil surface to receiving the web therebetween and to slit the web when the web travels in a machine direction, at least one of the slitters being a moveable slitter that is moveable in the transverse direction.

48-52. (canceled)

53. The book block finishing machine of claim 15, wherein the forming unit is operable to separate the web into at least two ribbons and further comprising a ribbon shifting unit to receive the at least two ribbons and to align each ribbon with a predetermined reference position.

54-62. (canceled)

63. The book block finishing machine of claim 15, wherein the forming unit is operable to separate the web into at least two ribbons and further comprising a compensator unit to receive the at least two ribbons and to longitudinally register each ribbon relative to at least one other ribbon.

64-68. (canceled)

69. A batcher unit for use in a book block finishing machine, the batcher unit comprising:
at least one hopper to receive a plurality of sheets to form a book block;
at least one adhesive applicator, each adhesive applicator operable to apply adhesive to at least one edge of the book block to bind together the plurality of sheets in the book block.

70-87. (canceled)

88. A shingle and interrupt unit comprising:
at least one first conveyor to receive a plurality of sheets, and at least a second conveyor downstream from each first conveyor,
each first conveyor operating at a first speed that is slower than a speed at which the first conveyor receives the plurality of sheets so that sequential ones of each plurality of sheets will be at least partially overlapped when they are transferred from a fast conveyor to the first conveyor forming at least one shingled stream;
each second conveyor selectably operable at a second speed that is faster than the first speed so that a gap can be formed between sequential ones of the plurality of sheets transferred from the first conveyor to the second conveyor;
at least one interrupter opposing each first conveyor, each interrupter movable between a rest position, in which the at least one shingled stream can flow in a downstream direction, and an activated position, in which the interrupter engages at least one sheet in the each of the at least one shingled streams to inhibit downstream movement of the at least one designated sheet.

89-101. (canceled)
